(19) United States
(12) Patent Application Publication
(10) Pub. No.: US 2026/0146628 A1
(43) Pub. Date: May 28, 2026

(54) BLADELESS FAN LAMP

(71) Applicant: Ningbo Goneo Electric Appliance Co., Ltd., Cixi, Ningbo, Zhejiang (CN)

(72) Inventors: Yulong Xu, Ningbo, Zhejiang (CN); Junjie Liao, Ningbo, Zhejiang (CN); Yinping Lin, Ningbo, Zhejiang (CN)

(21) Appl. No.: 19/479,970

(22) PCT Filed: Jun. 28, 2024
(86) PCT No.: PCT/CN2024/102743

§ 371 Date: Oct. 29, 2025

(30) Foreign Application Priority Data
Jun. 29, 2023 (CN) 202310786302.5
Jun. 29, 2023 (CN) 202321686278.X
Jun. 29, 2023 (CN) 202321688202.0
Jun. 29, 2023 (CN) 202321695489.X
Sep. 15, 2023 (CN) 202322523767.X

(51) Int. Cl. F04D 29/44; F04D 29/28; F21V 33/00

(52) U.S. Cl. CPC F04D 29/441; F04D 29/281; F21V 33/0096

(57) ABSTRACT

A bladeless fan lamp, comprising a fan mechanism, the fan mechanism comprising a wind wheel and a motor. An air inlet is formed in the top of the wind wheel, and an air outlet is formed in the side surface of the wind wheel, the air outlet being arranged in the circumferential direction of the wind wheel; the motor is connected to the wind wheel so as to drive the wind wheel to rotate. Such fan mechanism can enlarge an air outlet area.

The present disclosure is a US national stage of international application No. PCT/CN2024/102743, filed on Jun. 28, 2024, which claims priority to the Chinese Patent Application No. 202310786302.5 entitled “BLADELESS FAN LAMP” filed on Jun. 29, 2023, priority to the Chinese Utility Model Application No. 202321686278.X entitled “FAN ASSEMBLY AND BLOWING APPARATUS” filed on Jun. 29, 2023, priority to the Chinese Utility Model Application No. 202321695489.X entitled “ANTI-SHAKE BLADELESS FAN LAMP” filed on Jun. 29, 2023, priority to the Chinese Utility Model Application No. 202321688202.0 entitled “FAN MECHANISM WITH ANNULAR AIRFLOW AND HEAT DISSIPATION APPARATUS” filed on Jun. 29, 2023, and priority to the Chinese Utility Model Application No. 202322523767.X entitled “CEILING FAN AND FAN LAMP WITH LONG AIR DELIVERY DISTANCE AND EVEN ANNULAR AIRFLOW” filed on Sep. 15, 2023, the disclosures of which are incorporated herein by reference in their entireties.

### TECHNICAL FIELD

The present disclosure relates to the technical field of lighting, and in particular, relates to a bladeless fan lamp.

### BACKGROUND

A fan can accelerate the airflow in the environment. In daily life, a fan is an important tool for cooling and heat dissipation for people in high-temperature environments. With the development of the economy, bladeless fan technology has also been rapidly developed.

In the related art, a bladeless fan primarily uses a turbine-style fan wheel, and a motor rotor is directly connected to the turbine-style fan wheel to drive blades to rotate, thereby generating airflow.

### SUMMARY

The present disclosure provides a bladeless fan lamp. The bladeless fan lamp includes a fan mechanism, and the fan mechanism includes a fan wheel and a motor. An air inlet is formed on a top of the fan wheel, and an air outlet is formed on a side surface of the fan wheel, the air outlet being arranged along a circumferential direction of the fan wheel 11; and the motor is connected to the fan wheel to drive the fan wheel to rotate.

In some embodiments, the fan mechanism further includes a fan housing, the fan wheel and the motor are located within the fan housing, the fan wheel is spaced apart from the fan housing, and the motor is provided with a hollow shaft; and
the bladeless fan lamp further includes a lighting mechanism, the lighting mechanism includes a control assembly, a light-emitting assembly, and conductive members, where the conductive members pass through the hollow shaft and are electrically connected to the control assembly and the light-emitting assembly.

### BRIEF DESCRIPTION OF THE DRAWINGS

To describe the technical solutions in the embodiments of the present disclosure more clearly, the following briefly describes the accompanying drawings required for describing the embodiments. Apparently, the accompanying drawings in the following description show merely some embodiments of the present disclosure, and those of ordinary skill in the art may still derive other drawings from these accompanying drawings without creative efforts.

FIG. 1 is a first longitudinal cross-sectional view of a fan mechanism in a bladeless fan lamp according to an embodiment of the present disclosure;

FIG. 2 is a transverse cross-sectional view of a fan mechanism in a bladeless fan lamp according to an embodiment of the present disclosure;

FIG. 3 is a second longitudinal cross-sectional view of a fan mechanism in a bladeless fan lamp according to an embodiment of the present disclosure;

FIG. 4 is a first schematic structural diagram of a first air duct component (connected with a flow guide assembly) in a bladeless fan lamp according to an embodiment of the present disclosure;

FIG. 5 is a second schematic structural diagram of a first air duct component (connected with a flow guide assembly) in a bladeless fan lamp according to an embodiment of the present disclosure;

FIG. 6 is an exploded view of a fan mechanism in a bladeless fan lamp according to an embodiment of the present disclosure;

FIG. 7 is a bottom view of a fan mechanism (including hidden lines of blades) in a bladeless fan lamp according to an embodiment of the present disclosure;

FIG. 8 is a first exploded view of a bladeless fan lamp according to an embodiment of the present disclosure;

FIG. 9 is a first schematic structural diagram of a bladeless fan lamp according to an embodiment of the present disclosure;

FIG. 10 is a bottom view of a bladeless fan lamp according to an embodiment of the present disclosure;

FIG. 11 is a second schematic structural diagram of a bladeless fan lamp according to an embodiment of the present disclosure;

FIG. 12 is a first cross-sectional view of a bladeless fan lamp according to an embodiment of the present disclosure;

FIG. 13 is a second cross-sectional view of a bladeless fan lamp according to an embodiment of the present disclosure;

FIG. 14 is a third schematic structural diagram of a bladeless fan lamp according to an embodiment of the present disclosure;

FIG. 15 is a third cross-sectional view of a bladeless fan lamp according to an embodiment of the present disclosure;

FIG. 16 is a schematic diagram of a central angle occupied by both ends of a shielding tongue and a wind sensation radius according to some embodiments of the present disclosure;

FIG. 17 is a schematic diagram of a first wind direction of a bladeless fan lamp according to an embodiment of the present disclosure;

FIG. 18 is a schematic diagram of a second wind direction of a bladeless fan lamp according to an embodiment of the present disclosure;

FIG. 19 is a fourth schematic structural diagram of a bladeless fan lamp according to an embodiment of the present disclosure;

FIG. 20 is a schematic structural diagram of a flow guide member in a bladeless fan lamp according to an embodiment of the present disclosure;

FIG. 21 is a first cross-sectional view of a flow guide member in a bladeless fan lamp according to an embodiment of the present disclosure;

FIG. 22 is a second cross-sectional view of a flow guide member in a bladeless fan lamp according to an embodiment of the present disclosure;

FIG. 23 is a third cross-sectional view of a flow guide member in a bladeless fan lamp according to an embodiment of the present disclosure;

FIG. 24 is a second exploded view of a bladeless fan lamp according to an embodiment of the present disclosure;

FIG. 25 is a first schematic diagram of a demolding process of a flow guide member in a bladeless fan lamp according to an embodiment of the present disclosure;

FIG. 26 is a second schematic diagram of a demolding process of a flow guide member in a bladeless fan lamp according to an embodiment of the present disclosure;

FIG. 27 is a third schematic diagram of a demolding process of a flow guide member in a bladeless fan lamp according to an embodiment of the present disclosure;

FIG. 28 is a fourth schematic diagram of a demolding process of a flow guide member in a bladeless fan lamp according to an embodiment of the present disclosure;

FIG. 29 is a fifth schematic diagram of a demolding process of a flow guide member in a bladeless fan lamp according to an embodiment of the present disclosure;

FIG. 30 is a cross-sectional view of a bladeless fan lamp according to an embodiment of the present disclosure;

FIG. 31 is a first half cross-sectional view of a bladeless fan lamp according to an embodiment of the present disclosure;

FIG. 32 is a second half cross-sectional view of a bladeless fan lamp according to an embodiment of the present disclosure;

FIG. 33 is a first schematic structural diagram of a fan wheel in a bladeless fan lamp according to an embodiment of the present disclosure;

FIG. 34 is a second schematic structural diagram of a fan wheel in a bladeless fan lamp according to an embodiment of the present disclosure;

FIG. 35 is a first half cross-sectional view of a fan wheel in a bladeless fan lamp according to an embodiment of the present disclosure;

FIG. 36 is a second half cross-sectional view of a fan wheel in a bladeless fan lamp according to an embodiment of the present disclosure;

FIG. 37 is a schematic structural diagram of a blade in a bladeless fan lamp according to an embodiment of the present disclosure;

FIG. 38 is a cross-sectional view of a blade in a bladeless fan lamp according to an embodiment of the present disclosure; and

FIG. 39 is a half cross-sectional view of a bladeless fan lamp according to an embodiment of the present disclosure.

### REFERENCE NUMERALS

1. fan mechanism; 11. fan wheel; 111. air inlet; 112. air outlet; 113. bottom plate; 12. motor; 126. main body part; 127; output shaft; 13. fan housing; 131. outer housing; 1311. air intake; 132. air duct assembly; 1321. first air duct component; 13211. air inlet gap; 13212. bent part; 132121. vertical bent surface; 13213. first arc-shaped part; 1322. second air duct component; 13221. second connecting structure; 13222. second arc-shaped part; 1323. air duct space; 1324. annular opening; 13241. air outlet gap; 1325. support member; 133. flow guide assembly; 1331. flow guide member; 13311. flow guide surface; 13312. first air guide part; 13313. second air guide part; 133131. first sub-air guide surface; 133132. second sub-air guide surface; 13314. transition surface; 13315. first connecting structure; 134. fourth fastener; 2. lighting mechanism; 100. upper mold; 200. lower mold.

### DETAILED DESCRIPTION

The technical solutions in the embodiments of the present disclosure will be described hereinafter with reference to the accompanying drawings in the embodiments of the present disclosure, and it is apparent that the described embodiments are only a portion, but not all of the embodiments of the present disclosure. Based on the embodiments in the present disclosure, all other embodiments obtained by those of ordinary skill in the art without making creative efforts shall fall within the protection scope of the present disclosure.

In related art, a bladeless fan primarily uses a fan wheel to agitate airflow and direct the airflow into an air duct. However, the airflow tends to disperse significantly within the air duct and flows unevenly, resulting in a small air volume at the air outlet. Moreover, the airflow from the air outlet will blow directly onto the surface of the human skin, which is likely to cause discomfort and lead to health issues such as colds.

The embodiments of the present disclosure provide a fan mechanism which is capable of achieving annular airflow and is a bladeless fan mechanism. In normal usage scenarios, the blades 11 of the fan are hidden within the housing, and the fan has a better aesthetics and safety. The fan mechanism is applicable to a heat dissipation apparatus such as a bladeless electric fan or a bladeless fan lamp.

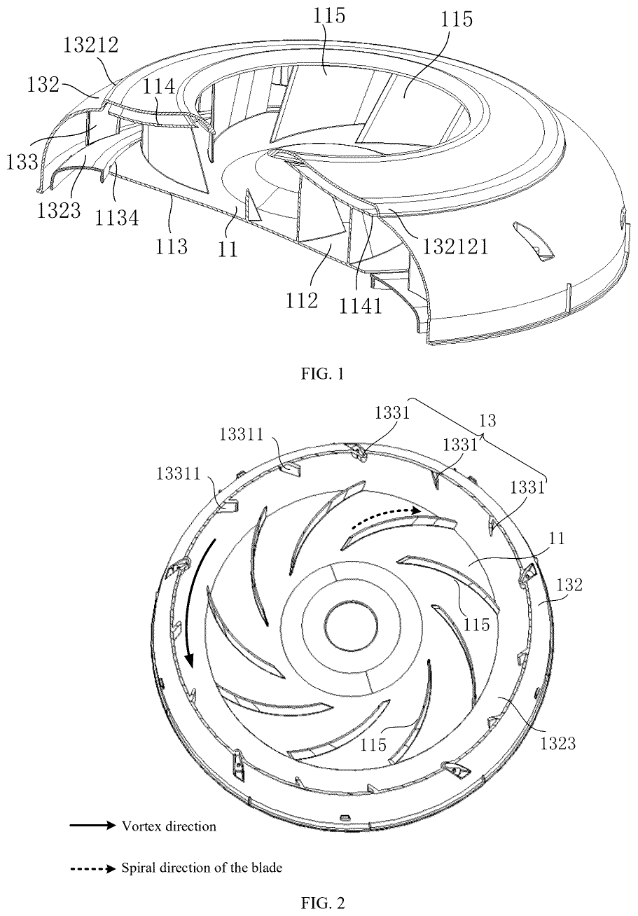

As shown in FIGS. 1 and 2, the fan mechanism 1 according to the embodiments of the present disclosure includes a fan wheel 11, an air duct assembly 132, and a flow guide assembly 133. The fan wheel 11 is provided with a plurality of blades 115, and the plurality of blades 115 are arranged in a vortex pattern; the air duct assembly 132 surrounds the fan wheel 11 and forms an air duct space 1323 along the circumferential direction of the fan wheel 11, and the air duct space 1323 communicates with the air outlet 112 of the fan wheel 11; and the flow guide assembly 133 is located inside the air duct space 1323 and is connected to the air duct assembly 132, and the flow guide assembly 133 is configured to guide the airflow blown out from the fan wheel 11 to flow along a circumferential direction. The guiding direction of the flow guide assembly 133 is opposite to the vortex direction of the plurality of blades 115.

In the embodiments of the present disclosure, “opposite direction” refers to the scenario where an extending direction from the center of the fan wheel (or a leading edge of the blade) towards a trailing edge of the blade and a guiding direction of the flow guide assembly 133 faces different sides. It should not be understood that it indicates the guiding direction and the vortex direction must be exactly 180° opposite.

As shown in FIGS. 1 and 2, the “arranged in a vortex pattern” refers to the scenario where in the direction from the center of the fan wheel 11 towards the edge (direction away from the rotation axis of the fan wheel 11), the distance between two adjacent blades 115 gradually increases; and the direction from the leading edge 1151 of the blade 115 to the trailing edge 1152 thereof intersects with the radial direction of the fan wheel 11. The leading edge 1151 is an edge on one side, close to the rotation axis of the fan wheel 11, of the blade 115, and the trailing edge 1152 is an edge on one side, away from the rotation axis, of the blade 115. This vortex pattern may also be referred to as a spiral pattern. The vortex (or spiral direction) may be determined as the direction from the leading edge 1151 of the blade 115 to the trailing edge 1152 thereof. For example, it is a clockwise direction in FIG. 2. Two adjacent blades 115 are spaced apart so as to divide the air outlet 112 of the fan wheel 11 into a plurality of air outlet gaps 13241. In the case that the motor 12 rotates, the airflow exits circumferentially through the air outlet 112, and the airflow direction of the air outlet 112 aligns with the vortex direction of the blades 115. In FIG. 2, for example, the air outlet 112 blows air in a clockwise direction.

A guiding direction of the flow guide assembly 133 is determined as a direction from a leading edge 1151 to a trailing edge 1152 of each flow guide member 1331 within the flow guide assembly 133. The leading edge 1151 of the flow guide member 1331 is an edge on one side, close to the rotation axis of the fan wheel 11, of the flow guide member 1331, and the trailing edge 1152 of the flow guide member 1331 is an edge on one side, away from the rotation axis, of the flow guide member 1331. In FIG. 2, the guiding direction of the flow guide assembly 133 is a counter-clockwise direction.

In the fan mechanism according to the embodiments of the present disclosure, the air duct assembly 132 encloses the air duct space 1323 in the circumferential direction of the fan wheel 11. The air duct space 1323 communicates with the air outlet 112 of the fan wheel 11, such that the airflow generated by the rotation of the fan wheel 11 (the fan wheel 11 is, for example, driven by a motor 12without being shown in the figure) flow out of the air outlet 112, flow through the air duct space 1323, and then be blown out. Since the flow guide assembly 133 is arranged within the air duct space 1323, and the guiding direction of the flow guide assembly 133 is opposite to the vortex direction (spiral direction) of the blades 115 and can guide the airflow within the air duct space 1323 to flow circumferentially, the airflow blown out from the air duct space 1323 is an annular airflow and provides a gentler breeze effect on the surface of human skin. Therefore, compared to fans in the related art that blow air directly, the fan mechanism 1 according to the embodiments of the present disclosure offers better user comfort during use and ensures the user's health.

In the embodiments of the present disclosure, as shown in FIGS. 1 and 2, the blades 115 used in the fan wheel 11 may be spiral blades 115, such that the trailing edge 1152 of the blade 115 is twisted relative to the leading edge 1151 of the blade 115. In some embodiments, a distance between the top of the leading edge 1151 of the blade 115 and the rotation axis of the fan wheel 11 is greater than a distance between the bottom of the leading edge 1151 and the rotation axis of the fan wheel 11. A distance between the top of the trailing edge 1152 of the blade 115 and the rotation axis of the fan wheel 11 is less than a distance between the bottom of the leading edge 1151 and the rotation axis of the fan wheel 11. In some embodiments, the spiral direction of the blade 115 is the same as the vortex direction of the blade 115.

The plurality of blades 115 are arranged in a vortex pattern, and the guiding direction of the flow guide assembly 133 needs to be opposite to the vortex direction of the blades 115. For example, in the case that the vortex direction of the blades 115 of the fan wheel 11 is right-handed which corresponds to a clockwise direction, and the guiding direction of the flow guide assembly 133 is accordingly a counter-clockwise direction. For another example, in the case that the vortex direction of the blades 115 of the fan wheel 11 is left-handed which corresponds to a counter-clockwise direction, and the guiding direction of the flow guide assembly 133 is accordingly a clockwise direction.

Referring to FIG. 2, in some embodiments, the flow guide assembly 133 includes a plurality of flow guide members 1331, and each flow guide member 1331 is provided with a flow guide surface 13311. The arrangement direction of the plurality of flow guide surfaces 13311 is opposite to the vortex direction of the blades 115, and the airflow blown out from the fan wheel 11 is adapted to flow along the arrangement direction of the plurality of flow guide surfaces 13311.

FIG. 2 illustrates the cross-sectional structure of a fan wheel 11 and an air duct assembly 132 (only the first air duct component 1321 is shown) according to some embodiments of the present disclosure. Taking the fan wheel 11 shown in FIG. 2 as an example, the vortex direction of the blades 115 of the fan wheel 11 is right-handed, which corresponds to a clockwise direction. In this case, the flow guide surfaces 13311 of the plurality of flow guide members 1331 are arranged along a counter-clockwise direction. After the airflow generated by the fan wheel 11 enters the air duct space 1323, the airflow flows along a counter-clockwise direction under the flow guide action of each flow guide surface 13311, thereby achieving the guiding function of the flow guide assembly 133 on the airflow within the air duct space 1323.

It should be noted that in the embodiments, for a fan wheel 11 with right-handed blades 115, it is typically chosen to drive the fan wheel 11 to rotate along a counter-clockwise direction, that is, the rotational direction of the fan wheel 11 is opposite to the vortex direction of the blades 115. Accordingly, driven by the fan wheel 11, the airflow blown out from the fan wheel also flows in a counter-clockwise direction. The plurality of flow guide surfaces 13311, which are also arranged along a counter-clockwise direction, will further guide the airflow to flow along a counter-clockwise direction and towards the outlet of the air duct space 1323, thereby ensuring that the airflow blown out from the air duct space 1323 is an annular airflow. For a fan wheel 11 with left-handed blades 115, it is typically chosen to drive the fan wheel 11 to rotate along a clockwise direction. Accordingly, the airflow blown out from the fan wheel 11 flows in a clockwise direction. The plurality of flow guide surfaces 13311, which are also arranged along a clockwise direction, will further guide the airflow to flow along a clockwise direction and towards the outlet of the air duct space 1323, thereby ensuring that the airflow blown out from the air duct space 1323 is an annular airflow. Annular airflow can act relatively gently on the surface of human skin, such that it is less likely to cause discomfort even after prolonged exposure, and thus the comfort of using the fan mechanism 1 is enhanced.

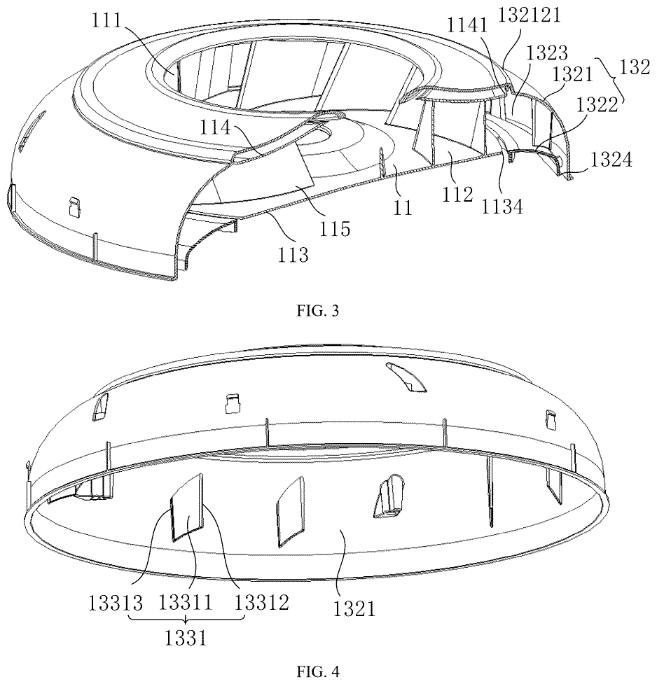

In some embodiments of the present disclosure, as shown in FIG. 3, the air duct assembly 132 includes a first air duct component 1321 and a second air duct component 1322. Both the first air duct component 1321 and the second air duct component 1322 are arranged to surround the air outlet 112 of the fan wheel 11. The first air duct component 1321 is adjacent to the top of the fan wheel 11, and the second air duct component 1322 is adjacent to the bottom of the fan wheel 11; and an air duct space 1323 is formed between the first air duct component 1321 and the second air duct component 1322. One end, away from the fan wheel 11, of the first air duct component 1321 as well as one end, away from the fan wheel, of the second air duct component 1322 are close to each other and a gap is provided therebetween, such that an annular opening 1324 is formed. The annular opening 1324 can serve as the vent of a bladeless fan lamp for discharging the airflow blown out from the fan wheel 11.

In the embodiments of the present disclosure, the air inlet 111 is typically located at the top of the fan wheel 11, while the air outlet 112 is located on the side surface of the fan wheel 11 and is formed circumferentially. The first air duct component 1321 and the second air duct component 1322 are both circumferentially formed on the side surface of the fan wheel 11. The first air duct component 1321 is adjacent to the top of the fan wheel 11 and the second air duct component 1322 is adjacent to the bottom of the fan wheel 11, such that an annular air duct space 1323 is formed between the first air duct component 1321 and the second air duct component 1322, and the entrance of the air duct space 1323 faces and communicates with the air outlet 112 of the fan wheel 11 to ensure that the airflow blown out from the fan wheel 11 enters the air duct space 1323 in the maximum extent. The bottom of the fan wheel 11 is arranged opposite to the top.

As shown in FIGS. 1 and 3, the fan wheel 11 includes a top plate 114 and a bottom plate 113, and blades 115 are fixed between the top plate 114 and the bottom plate 113. The first air duct component 1321 at least partially covers one side, away from the bottom plate 113, of the top plate 114 and bends in the direction towards the second air duct component 1322 at a first circumferential edge 1141 of the top plate 114 to form a bent part 13212. The bent part 13212 includes a vertical bent surface 132121, and the vertical bent surface 132121 is at least partially located on the outer side of the top plate 114. The first circumferential edge 1141 is the edge on one side, away from the rotation axis of the fan wheel 11, of the top plate 114. It is understood that compared to two portions adjacent to the vertical bent surface 132121 in the radial direction of the fan wheel 11, the angle between the vertical bent surface 132121 and the rotation axis of the fan wheel 11 is the smallest, so the vertical bent surface 132121 tends to extend along the height direction (vertical direction). In some embodiments, the vertical bent surface 132121 is parallel to the height direction or intersects with the height direction at a certain angle.

Exemplarily, a lower end of the vertical bent surface 132121 may be not lower than a bottom end of the top plate 114, such that the vertical bent surface 132121 does not block the air outlet 112 of the fan wheel 11.

In some embodiments, the air duct assembly 132 is spaced apart from the fan wheel 11, such that the air duct assembly 132 can remain stationary when the fan wheel 11 rotates. The flow guide member 1331 is arranged within the air duct space 1323 enclosed by the first air duct component 1321 and the second air duct component 1322. The edge, close to the rotation axis of the fan wheel 11, of the flow guide member 1331 does not extend beyond the edges, close to the rotation axis of the fan wheel 11, of the first air duct component 1321 and the second air duct component 1322. The blades 115 are arranged between the top plate 114 and the bottom plate 113, and the edges, away from the rotation axis of the fan wheel 11, of the blades 115 do not extend beyond the edges, away from the rotation axis of the fan wheel 11, of the top plate 114 and bottom plate 113, to avoid interference with the air duct assembly 132 when the fan wheel 11 rotates.

As shown in FIGS. 1 and 3, the vertical bent surface 132121 is spaced apart from the first circumferential edge 1141 of the top plate 114, and a radial distance between the vertical bent surface 132121 and the first circumferential edge 1141 is less than a radial distance between the flow guide member 1331 and the first circumferential edge 1141.

In the height direction from the bottom plate 113 towards the top plate 114, the second air duct component 1322 is not higher than the bottom plate 113. In this way, the second air duct component 1322 does not block the air outlet 112 of the fan wheel 11. In other words, in the height direction, the dimension of the entrance of the air duct space 1323 is greater than or approximately equal to the dimension of the air outlet 112 of the fan wheel 11, and thus it is achieved that the entrance of the air duct space 1323 faces and communicates with the air outlet 112 of the fan wheel 11, such that the airflow from the air outlet 112 can enter the air duct space 1323 in the maximum extent.

In some embodiments, as shown in FIGS. 1 and 3, the second air duct component 1322 is spaced apart from the second circumferential edge 1134 of the bottom plate 113, and a radial distance between the second air duct component 1322 and the second circumferential edge 1134 is less than a distance between the flow guide member 1331 and the second circumferential edge 1134. The second circumferential edge 1134 is an edge on one side, away from the rotation axis of the fan wheel 11, of the bottom plate 113.

It is understood that the flow guide member 1331 may be obliquely arranged relative to the circumferential direction of the fan wheel 11, causing different positions on the flow guide member 1331 to have different radial distances from the rotation axis of the fan wheel 11. As a result, different positions on the flow guide member 1331 have different radial distances to the first circumferential edge 1141 or the second circumferential edge 1134. In the embodiments of the present disclosure, a radial distance between the flow guide member 1331 and the first circumferential edge 1141 is determined as a radial distance between the position, closest to the rotation axis of the fan wheel 11, on the flow guide member 1331 and the first circumferential edge 1141, i.e., the minimum radial distance between the flow guide member 1331 and the first circumferential edge 1141 of the top plate 114. A radial distance between the flow guide member 1331 and the second circumferential edge 1134 is determined as a radial distance between the position, closest to the rotation axis of the fan wheel 11, on the flow guide member 1331 and the first circumferential edge 1141, i.e., the minimum radial distance between the flow guide member 1331 and the first circumferential edge 1141 of the top plate 114.

In some embodiments, as shown in FIGS. 1 and 2, the first circumferential edge 1141 of the top plate 114 and the second circumferential edge 1134 of the bottom plate 113 are substantially flush in the radial direction of the fan wheel 11. The trailing edge 1152 on one side, away from the rotation axis, of the blade 115 is flush with both the first circumferential edge 1141 of the top plate 114 and the second circumferential edge 1134 of the bottom plate 113.

In the case that the fan wheel 11 is in operation, air is drawn in through the air inlet 111 on the top and forms an airflow, which flows through the blades 115 and is blown out through the air outlet 112 and enters the air duct space 1323, and then an annular airflow is formed under the action of the flow guide assembly 133 and is blown out from the air duct space 1323.

As shown in FIG. 3, the farther the first air duct component 1321 and the second air duct component 1322 are from the fan wheel 11, the closer they are to each other. Therefore, the farther the formed air duct space 1323 from the fan wheel 11 in the radial direction, the smaller the cross-sectional area thereof, which helps to concentrate the airflow blown out from the fan wheel 11, and improve the air outlet efficiency and the air delivery distance at the outlet of the air duct space 1323. The outlet of the air duct space 1323 is enclosed by the end, away from the fan wheel 11, of the first air duct component 1321 and the end, away from the fan wheel 11, of the second air duct component 1322.

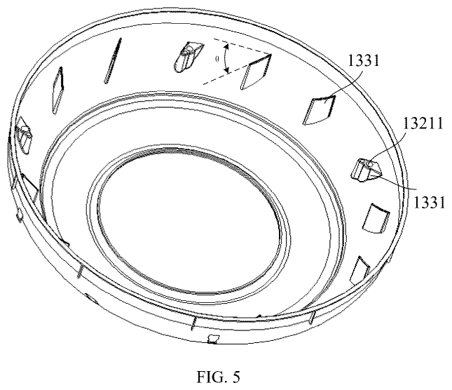

In some embodiments of the present disclosure, as shown in FIG. 4, the flow guide members 1331 are connected to the first air duct component 1321 and are obliquely arranged relative to the inner wall of the first air duct component 1321. The flow guide surface 13311 is a surface, facing away from the first air duct component 1321, of the flow guide member 1331. A direction from a first end to a second end of the flow guide surface 13311 is parallel to a tangential direction of the arrangement direction of the plurality of flow guide surfaces 13311. The first end is one end away from the first air duct component 1321, and the second end is one end connected to the first air duct component 1321.

Referring to FIGS. 2 and 4, each flow guide member 1331 is obliquely connected to the inner wall of the first air duct component 1321and thus the flow guide member 1331 may be provided with a surface facing the inner wall of the first air duct component 1321 and a flow guide surface 13311 facing away from the inner wall of the first air duct component 1321. In the case that the airflow blown out from the fan wheel 11 impacts on the flow guide surface 13311, in an aspect, the airflow will flow along the flow guide surface 13311 from the first end to the second end, where the first end is opposite the second end, and in another aspect, the airflow will be pressurized by the flow guide member 1331, such that the dispersion degree of the airflow is reduced and the airflow is made more concentrated. Therefore, the flow guide member 1331 can achieve the effect of guiding and concentrating the divergent airflow blown out from the fan wheel 11, and further increase the volume and distance of air delivery at the outlet of the air duct space 1323.

In some embodiments, as shown in FIG. 3, the flow guide member 1331 abuts against the second air duct component 1322. Exemplarily, the top end of the flow guide member 1331 is connected to the first air duct component 1321, one side edge adjacent to the top end is also connected to the first air duct component 1321, and the lower end of the flow guide member 1331 abuts against the second air duct component 1322.

Optionally, each flow guide member 1331 has a chordal tangent angle on the first air duct component 1321 that is greater than a 15° and is less than 90°. The chordal tangent angle refers to the angle between the tangent at the contact point of the first air duct component 1321 and the flow guide member 1331 (or a tangent of the flow guide member 1331 at the contact point) in a defined plane. The defined plane is perpendicular to the rotation axis of the fan wheel 11, and the contact point is an intersection point of the first air duct component 1321 and the flow guide member 1331 on the defined plane. As shown in FIG. 5, the chordal tangent angle of the flow guide member 1331 on the first air duct component 1321 is represented by θ, where 15°<θ<90°. Exemplarily, the chordal tangent angle θ may be 30°, 40°, 50°, or 60°.

Optionally, the flow guide surface 13311 of at least one flow guide member 1331 is a curved surface, which curves in a direction facing away from the first air duct component 1321.

As shown in FIG. 5, there is at least one flow guide member 1331 among the plurality of flow guide members 1331 which is a curved plate. Therefore, the flow guide surface 13311 of the flow guide member 1331 is a curved surface, and airflow is suitable for flowing over the convex side of the curved surface. Optionally, the shape of the flow guide surface 13311 is arc-shaped.

In some embodiments of the present disclosure, there is at least one flow guide member 1331 among the plurality of flow guide members 1331 that is provided with a first connecting structure 13315. A second connecting structure 13221 is arranged at a position, which corresponds to the first connecting structure 13315, on the second air duct component 1322, and the second connecting structure 13221 connects or cooperates with the first connecting structure 13315.

In one example, the first connecting structure 13315 and the second connecting structure 13221 are connected to each other. The first connecting structure 13315 may be a hook or a slot while the second connecting structure 13221 may accordingly be a slot or a hook. During assembly, the hook snaps into the corresponding slot, such that the first air duct component 1321 and the second air duct component 1322 are connected together.

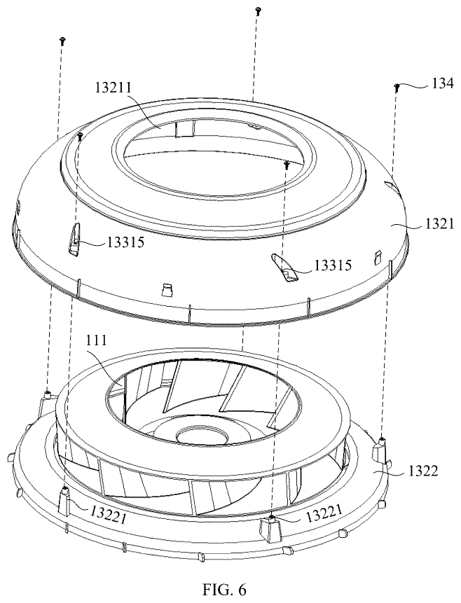

In another example, as shown in FIG. 6, the first connecting structure 13315 and the second connecting structure 13221 cooperate with each other. The first connecting structure 13315 is a screw hole running through the first air duct component 1321 and the flow guide member 1331 along the height direction, and the second connecting structure 13221 is a screw hole formed on the second air duct component 1322. The first air duct component 1321 and the second air duct component 1322 are connected together by a fourth fastener 134 installed in the first connecting structure 13315 and the second connecting structure 13221. The fourth fastener 134 is, for example, a screw. The thickness of the flow guide member 1331 which is provided with the first connecting structure 13315 is greater than the thickness of the other flow guide members 1331 to ensure the strength of the first connecting structure 13315.

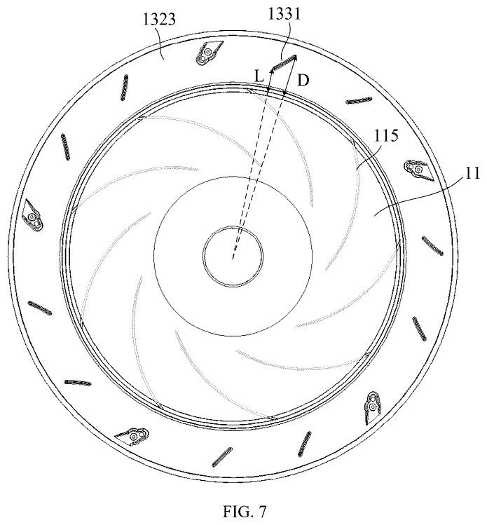

FIG. 7 illustrates a bottom view of a mating structure between the fan wheel 11 and the first air duct component 1321 according to some embodiments of the present disclosure. In the figure, darker (black) solid lines are used to represent the structural features of the fan wheel 11 exposed to the external view, while lighter (gray) solid lines are used to represent the blades 115 hidden inside the fan wheel 11. Moreover, in FIG. 7, L is used to illustrate a distance between the flow guide member 1331 and the blade 115, such as the minimum distance between the flow guide member 1331 and the outer edge of the blade 115; and D is used to illustrate a width of the air duct space 1323, i.e., the minimum distance between the end, which is connected to the first air duct component 1321, of the flow guide member 1331 and the outer edge of the blade 115. In the embodiments of the present disclosure, the distances may use radial distances in the radial direction of the fan wheel 11.

In the embodiments of the present disclosure, the distance L between the flow guide member 1331 and the blade 115 of the fan wheel 11 may be determined based on the diameter of the fan wheel 11 and the dimension of the air duct outlet (annular opening 1324). In the case that the distance L between the flow guide member 1331 and the blade 115 of the fan wheel 11 is too large, the guiding effect is poor. In the case that the distance L between the flow guide member 1331 and the blade 115 of the fan wheel 11 is too small, the amount of air output will be reduced and air output distance will be shortened and thus the airflow effect is affected. Optionally, the distance L between the flow guide member 1331 and the blade 115 of the fan wheel 11 is 0.3 to 0.7 times the width D of the air duct space 1323. Further, the distance L between the flow guide member 1331 and the blade 115 of the fan wheel 11 is 0.5 to 0.6 times the width D of the air duct space 1323. Exemplarily, it is 0.57 times, and tests indicate that at this ratio, the fan mechanism 1 achieves both good guiding and airflow effects.

In some embodiments of the present disclosure, the number of the flow guide member 1331 is greater than or equal to the number of the blade 115 of the fan wheel 11.

Within a certain range, the more flow guide members 1331 there are, the more evenly the airflow from the blades 115 is distributed, and the better guiding effect is. However, in the case that there are too many flow guide members 1331, it is likely to result in the blockage of the airflow within the air duct space 1323, and thus the air amount is decreased, the airflow velocity is reduced, distance of air output is shortened, and the airflow effect is affected. Optionally, the number of flow guide members 1331 is 1.1 to 3 times the number of blades 115. Further, the number of flow guide members 1331 is 1.5 to 2 times the number of blades 115. Exemplarily, the ratio of flow guide members 1331 to blades 115 is 5:3 and tests indicate that at this ratio, the fan mechanism 1 achieves both good guiding and airflow effects.

In summary, the fan mechanism 1 according to the embodiments of the present disclosure is provided with the air duct space 1323 enclosed by the first air duct component 1321 and the second air duct component 1322; and the air duct space 1323 surrounds the outer side of the air outlet 112 of the fan wheel 11. A plurality of flow guide members 1331 are arranged within the air duct space 1323, and the number of the flow guide members 1331 is no less than the number of the blades 115 of the fan wheel 11. Each flow guide member 1331 is obliquely connected to the inner wall of the first air duct component 1321, and the distance between the flow guide member 1331 and the blades 115 is 0.3 to 0.7 times the width of the air duct space 1323. The flow guide members 1331 are provided with flow guide surfaces 13311, and the plurality of flow guide surfaces 13311 cooperate to guide the flow direction of the airflow blown out from the fan wheel 11. The guiding direction is opposite to the vortex direction of the blades 115 of the fan wheel 11, such that the airflow is guided by the flow guide surfaces 13311 within the air duct space 1323, and then an annular airflow with a flow direction opposite to the vortex direction of the blades 115 is formed and blown out. Since the annular airflow provides a gentler breeze effect on the surface of human skin, compared to fans in the related art that blow air directly, the fan mechanism 1 according to the embodiments of the present disclosure offers better user comfort during use and ensures the user's health.

The embodiments of the present disclosure further provide a heat dissipation apparatus, which includes the fan mechanism 1 with annular airflow described in any one of the above embodiments. Exemplarily, the heat dissipation apparatus is a bladeless electric fan, a bladeless fan lamp, or the like.

Optionally, the heat dissipation apparatus further includes a housing which is provided with an air outlet opening (such as the air intake 1311 described above). The fan mechanism 1 is located inside the housing, and an outlet of the air duct space 1323 of the fan mechanism 1 is in communication with a corresponding air outlet opening.

The heat dissipation apparatus according to the embodiments of the present disclosure uses the fan mechanism 1 with annular airflow, so the air duct assembly 132 can enclose an air duct space 1323 in the circumferential direction of the fan wheel 11. The air duct space 1323 communicates with the air outlet 112 of the fan wheel 11, such that the airflow generated by the rotation of the fan wheel 11 flows out through the air outlet 112, passes through the air duct space 1323, and is then blown out. Since the flow guide assembly 133 is arranged within the air duct space 1323, and the guiding direction of the flow guide assembly 133 is opposite to the vortex direction of the blades 115 and can guide the airflow within the air duct space 1323 to flow circumferentially, the airflow blown out from the air duct space 1323 is an annular airflow and provides a gentler breeze effect on the surface of human skin. Therefore, compared to fans in the related art that blow air directly, the heat dissipation apparatus according to the embodiments of the present disclosure offers better user comfort during use, and ensures the user's health.

In the above embodiments, the blade 115 may be a spiral blade 115, and the flow guide member 1331 may be illustrated as a single plate-shaped component. In other embodiments, the blade 115 may be also a single plate-shaped component, and the flow guide member 1331 may be a convex structure provided with at least two intersecting planes.

As shown in FIG. 8, the embodiments of the present disclosure provide a fan mechanism 1, which is installed on the ceiling in a suspended manner, and thus the fan mechanism 1 is also referred to as a ceiling fan, and the fan mechanism 1 is applicable to a bladeless fan lamp. As shown in FIGS. 12 and 13, the fan mechanism 1 includes an air duct assembly 132 (which may serve as a casing for the fan wheel), a fan wheel 11, and a plurality of flow guide members 1331.

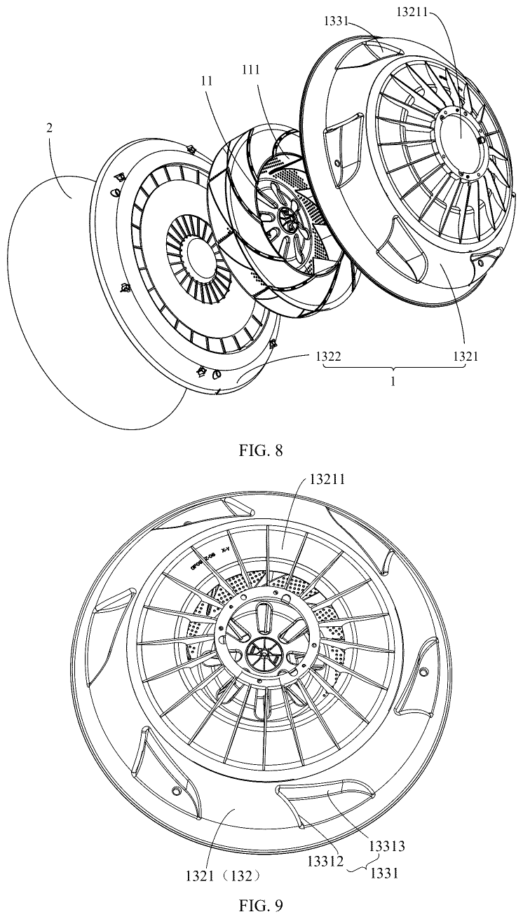

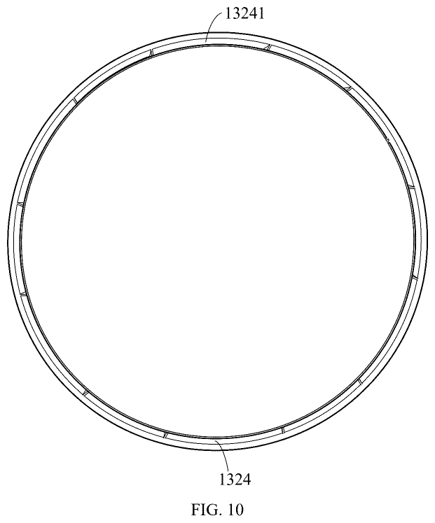

As shown in FIGS. 9 and 10, air inlet gaps 13211 are formed on the top of the air duct assembly 132, and annular openings 1324 are formed on the bottom. The fan wheel 11 is located inside the air duct assembly 132, for example, in the space enclosed on one side, away from the first air duct component 1321, of the second air duct component 1322. Therefore, the air duct component may be also referred to as a casing, which cooperates with the outer housing 131 described above to form the fan housing 13. The first air duct component 1321 located on the outer side may be referred to as the outer casing, and the second air duct casing located on the inner side may be referred to as the inner casing.

The flow guide member 1331 surrounds the fan wheel 11. The flow guide member 1331 is provided with a first air guide part 13312, and the tail end of the first air guide part 13312 is connected to the air duct assembly 132 (for example, the first air duct component 1321). In a reference plane perpendicular to the rotation axis of the fan wheel 11, a connection line between a head end of the first air guide part 13312 and the central axis of the annular opening 1324 is set as a first reference line a, and a connection line between a tail end of the first air guide part 13312 and the rotation axis is set as a second reference line c; and the second reference line c and the first reference line a are arranged sequentially in the circumferential direction along the rotational direction of the fan wheel 11. The first air guide part 13312 is arc-shaped, and the concave surface of the first air guide part 13312 faces away from the fan wheel 11.

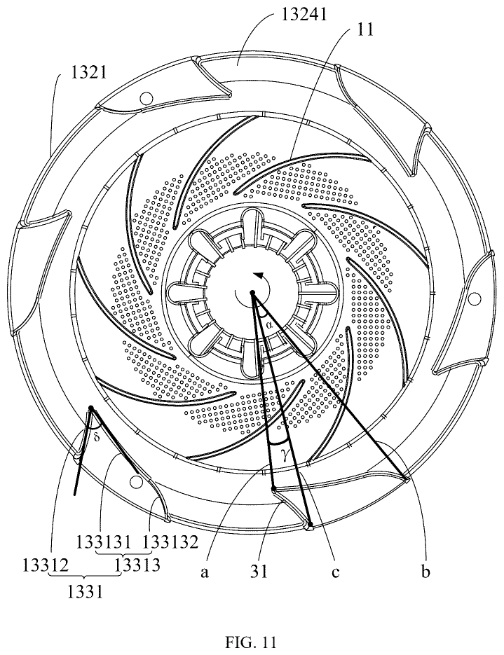

Since the annular opening 1324 on the air duct assembly 132 is formed around the rotation axis of the fan wheel 11, the central axis of the annular opening 1324 may be the rotation axis of the fan wheel 11, such that the reference plane is perpendicular to the central axis of the annular opening 1324. It is understood that the rotational direction of the fan wheel 11 is not limited to the clockwise direction or the counter-clockwise direction, and it can actually indicate the circumferential (annular) direction of the fan wheel 11. Thus, based on FIG. 11, it is evident that the second reference line c and the first reference line a are sequentially arranged along the circumferential direction of the fan wheel 11.

The annular opening 1324 is divided by the flow guide members 1331 into a plurality of air outlet gaps 13241 arranged in an annular configuration. In the case that the flow guide member 1331 (also referred to as the air guide member) only includes the first air guide part 13312, the first air guide part 13312 divides the annular opening 1324 into a plurality of continuously arranged air outlets 112. In the case that the flow guide member 1331 only includes the first air guide part 13312, the surface of one side, facing away from the first air duct casing, of the first air guide part 13312 serves as the flow guide surface 13311 in the above embodiments.

In the fan mechanism (bladeless fan lamp) according to the embodiments of the present disclosure, as shown in FIG. 11, the second reference line c and the first reference line a are arranged along the rotational direction of the fan wheel 11, such that the deflection direction of the first flow guide part can align with the rotational direction of the fan wheel 11, and the deflection direction of the first flow guide part is made to be close to the airflow direction from the fan wheel 11, which can prevent intense collisions between the airflow and the first flow guide part and reduce noise generated by the airflow.

The first air guide part 13312 is arc-shaped. In an aspect, compared to a straight-shaped first air guide part 13312, setting the first air guide part 13312 as arc-shaped can increase the length of the first air guide part 13312, and thus the pressurization path of the airflow is increased which is beneficial for increasing wind pressure. Since the second air guide part 13313 is longer, it can reduce the pressure difference between the tail ends of the second air guide part 13313 and the first air guide part 13312 by increasing the length of the first air guide part 13312, thereby resulting in more even airflow from the annular opening 1324. In another aspect, the first air guide part 13312 can deflect the airflow radially towards the fan wheel 11, such that the airflow has a larger radial component after flowing towards the annular opening 1324, which is beneficial for the airflow to reach a greater distance.

In some examples, as shown in FIG. 13, the fan wheel 11 includes a plurality of blades 115which are arranged in an annular configuration and surround the air inlet 111 on the fan (or the air inlet gap 13211 of the air duct assembly 132). In the reference plane perpendicular to the rotation axis of the fan wheel 11, a connection line between a tail end of a blade 115 and a central axis of the fan wheel 11 is set as the third reference line m; a straight line perpendicular to the third reference line m at the tail end of the blade 115 is set as the fourth reference line n; an obtuse angle formed between the fourth reference line n and a connection line between a head end and the tail end of the blade 115 is set as λ1; a connection line between a head end of the first air guide part 13312 and the rotation axis (central axis) of the fan wheel 11 is set as the fifth reference line p; a straight line perpendicular to the fifth reference line p at the head end of the first air guide part 13312 is set as the sixth reference line q; and an acute angle formed between the sixth reference line q and the tangent at the head end of the first air guide part 13312 is set as λ2, where λ1-90°≤λ2≤λ1-80°.

When the airflow passes through the fan wheel 11, the airflow has component velocities in a first direction and a second direction. The first direction is a direction of the third reference line m, and the second direction is a direction of the connection line between the head end and the tail end of the blade 115. Therefore, the absolute velocity of the airflow is between the first direction and the second direction.

By setting λ1-90°≤λ2≤λ1-80°, the direction of the tangent at the head end of the first air guide part 13312 can be located between the first direction and the second direction, such that the airflow can be as parallel as possible to the head end of the first air guide part 13312. In this way, the impact of the airflow on the first air guide part 13312 can be reduced, thereby decreasing the noise generated by the airflow.

In some examples, as shown in FIG. 13, a connection line between the tail end of the first air guide part 13312 and the rotation axis of the fan wheel 11 is set as the seventh reference line e; a straight line perpendicular to the seventh reference line e at the tail end of the first air guide part 13312 is set as the eighth reference line f; and an acute angle formed between the eighth reference line f and the tangent at the tail end of the first air guide part 13312 is λ3, where λ2+20°≤λ3≤λ2+40°.

In this way, the tail end of the first air guide part 13312 can be as close as possible to the radial direction of the fan wheel 11, such that the airflow deflects along the radial direction of the fan wheel 11 when flowing from the tail end of the first air guide part 13312. As a result, the airflow becomes more concentrated, which can reduce airflow losses and is beneficial for the airflow to be blown to a greater distance. The farther the airflow is blown, the more easily the air blown from each air outlet gap 13241 is continuous in the circumference, thereby enhancing the uniformity of the annular airflow effect of the ceiling fan (bladeless fan lamp). In the case that the difference between λ3 and λ2 is too large, it may cause the deflection direction at the tail end of the first air guide part 13312 to be opposite to the deflection direction at the head end of the first air guide part 13312, leading to a deviation of the first air guide part 13312 from the radial direction of the fan wheel 11.

In some examples, as shown in FIG. 12, the leading edge 1151 of the blade 115 is provided with a forward protrusion structure 11511which is located between the top and bottom of the leading edge 1151 and protrudes in the direction towards the air inlet 111 (or the air inlet gap 13211). The leading edge 1151 is the edge, close to the air inlet 111, of the blade 115. A distance between the top of the leading edge 1151 and the rotation axis of the fan wheel 11 is set as R1, a distance between the bottom of the leading edge 1151 and the rotation axis is set as R2, and a distance between the forward protrusion structure 11511 and the rotation axis is set as R3, where R1>R3 and R2>R3. A height of the top of the head end of the first air guide part 13312 is lower than a height of the forward protrusion structure 11511.

Based on FIG. 12, it is evident that the leading edge 1151 of the blade 115 is the edge, close to the rotation axis of the fan wheel 11, of the blade 115; and the trailing edge 1152 is the edge, away from the rotation axis of the fan wheel 11, of the blade 115.

According to biomimetic principles, it is known that the forward protrusion structure 11511 can mimic the protrusion structure at the leading edge of a bird's wing to reduce vortices at the leading edge 1151 of the blade 115, which makes the airflow smoother such that the air resistance encountered by the leading edge 1151 of the blade 115 is reduced and then the wind noise at the leading edge 1151 is decreased.

In the case that the top of the head end of the first air guide part 13312 is higher than that of the forward protrusion structure 11511, it will result in an overall increased height of the first air guide part 13312 and thus the thickness of the ceiling fan is greater, and the ceiling fan is larger in volume and heavier.

In some examples, as shown in FIG. 12, the air duct assembly 132, which serves as the casing, includes a first air duct component 1321 (also referred to as the outer casing) and a second air duct component 1322 (also referred to as the inner casing). The first air duct component 1321 is sleeved on the second air duct component 1322, the first air duct component 1321 is provided with an air inlet gap 13211, and an annular opening 1324 is formed between the bottom of the first air duct component 1321 and the bottom of the second air duct component 1322. The top of the head end of the first air guide part 13312 is connected to the first air duct component 1321, and the bottom of the head end of the first air guide part 13312 is connected to the second air duct component 1322. The bottom of the head end of the first air guide part 13312 is located below the bottom of the fan wheel 11. In the case that the bottom of the head end of the first air guide part 13312 is located above the bottom of the fan wheel 11, a position where the second air duct component 1322 and the bottom of the head end of the first air guide part 13312 are connected will also be located above the bottom of the fan wheel 11, which obstructs the airflow from the fan wheel 11.

In some examples, as shown in FIG. 12, the height of the trailing edge 1152 of the blade 115 is set as H1, and a height difference between the top of the head end of the first air guide part 13312 and the forward protrusion structure 11511 is set as H2, where H2≤0.2H1. The trailing edge 1152 is opposite the leading edge 1151. According to simulation and test data, it is known that in the case that 0<H2≤0.2H1, the first air guide part 13312 exhibits the best guiding effect with minimal noise generation. In the case that H2 is too large, the height of the first air guide part 13312 would be too low, such that the airflow cannot be quickly guided by the first air guide part 13312 after flowing from the blade 115. Instead, the airflow is more likely to collide directly with the air duct assembly 132, thereby causing the airflow to generate greater noise.

In some examples, the height of the bottom of the head end of the first air guide part 13312 is higher than the height of the bottom of the tail end of the first air guide part 13312. And/or, the height of the bottom of the head end of the first air guide part 13312 is lower than the height of the fan wheel 11 at the rotation axis. In this way, a downward air duct can be formed within the housing. In the case that the airflow passes through the forward protrusion structure 11511, the main intake portion is directed downward to the first air guide part 13312 and then flows towards the annular opening 1324. Therefore, there is a gradual change in the flow direction of the airflow, which avoids the generation of greater noises caused by sudden changes in the airflow at the annular opening 1324.

In some examples, along the direction from the air inlet 111 towards the annular opening 1324 (i.e., along the height direction from top to bottom), the distance between the head end of the first air guide part 13312 and the rotation axis of the fan wheel 11 (or the central axis of the annular opening 1324) gradually increases or decreases. In this way, it ensures that the airflow does not collide with all positions of the head end of the first air guide part 13312 simultaneously. For example, along the direction from the air inlet 111 towards the annular opening 1324, the distance between the head end of the first air guide part 13312 and the central axis of the annular opening 1324 gradually increases, such that the top of the head end of the first air guide part 13312 is closest to the blade 115. Therefore, after flowing out of the blade 115, the airflow first collides with the top of the head end of the first air guide part 13312 and then with the bottom, thereby reducing the collision intensity between the airflow and the first air guide part 13312 and then lowering the noise generated by the airflow.

In some examples, as shown in FIG. 12, the distance between the top of the head end of the first air guide part 13312 and the rotation axis of the fan wheel 11 is set as L1, and the distance between the bottom of the head end of the first air guide part 13312 and the rotation axis is set as L2; and the maximum radius of the fan wheel 11 is set as R, where L2>L1, and 0.05L2−R≤L2−L1≤0.2L2−R.

The air duct assembly 132 includes a first air duct component 1321 and a second air duct component 1322. The first air duct component 1321 is sleeved on the second air duct component 1322. The first air duct component 1321 is provided with an air inlet 111, and an annular opening 1324 is formed between the bottom of the first air duct component 1321 and the bottom of the second air duct component 1322. Along the direction from the air inlet 111 towards the annular opening 1324, the distance between the first air duct component 1321 and the central axis of the annular opening 1324 gradually increases, and the distance between the head end of the first air guide part 13312 and the central axis of the annular opening 1324 gradually increases.

Since the distance between the first air duct component 1321 and the central axis of the annular opening 1324 gradually increases along the direction from the air inlet 111 towards the annular opening 1324, in the case that L2<L1, the distance between the head end of the bottom of the first air guide part 13312 and the first air duct component 1321 would be too large, such that the air guide path at the bottom of the first air guide part 13312 is longer, thereby increasing the pressurization path of the airflow, which would lead to a higher wind pressure at the tail end of the bottom of the first air guide part 13312, and cause the noise generated by the airflow to be increased.

For the condition 0.05L2−R≤L2−L1≤0.2L2−R, in the case that L2−L1 is too large, it will cause the top of the head end of the first air guide part 13312 to be too close to the trailing edge 1152 of the blade 115, such that the airflow velocity is higher when the airflow reaches the top of the head end of the first air guide part 13312, thereby leading to a stronger impact with the first air guide part 13312 and generating more noise. In the case that L2−L1 is too small, it will cause the bottom of the head end of the first air guide part 13312 to be too far from the trailing edge 1152 of the blade 115, such that the wind velocity is lower when the airflow reaches the bottom of the head end of the first air guide part 13312, thereby leading to a reduced air delivery distance of the ceiling fan.

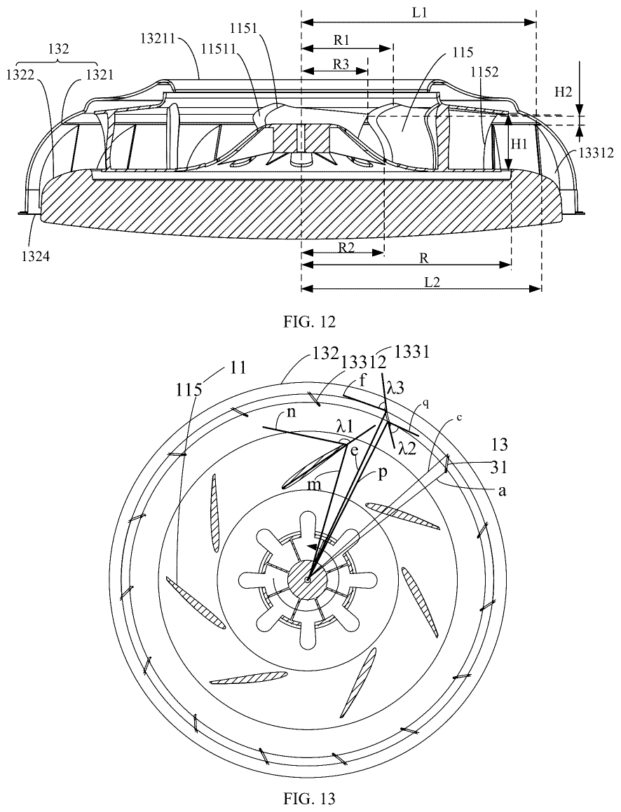

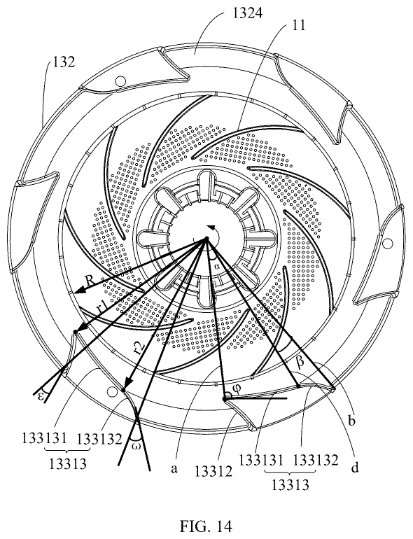

In some examples, as shown in FIG. 14, in the reference plane, an angle between the tangent at the tail end of the first air guide part 13312 and a connection line between the tail end of the first air guide part 13312 and the rotation axis of the fan wheel 11 (or the central axis of the annular opening 1324) is set as ε, where 0°<ε<20°. In this way, it can make the angle between the wind direction at the tail end of the first air guide part 13312 and the radial direction of the annular opening 1324 to be smaller, such that the first air guide part 13312 can deflect the airflow direction towards the radial direction of the ceiling fan, which is beneficial for increasing the radial air delivery distance of the ceiling fan.

As shown in FIGS. 8 to 11, the ceiling fan (bladeless fan lamp) includes the air duct assembly 132, the fan wheel 11, and the plurality of flow guide members 1331. The fan wheel 11 is provided with the air inlet 111, the air duct assembly 132 is provided with the air inlet gap 13211, and the bottom of the air duct assembly 132 is provided with the annular opening 1324. The fan wheel 11 is located inside the air duct assembly 132, and the plurality of flow guide members 1331 surround the fan wheel 11 and divide the annular opening 1324 into the plurality of air outlet gaps 13241. Each flow guide member 1331 is provided with the second air guide part 13313 and the first air guide part 13312. The second air guide part 13313 faces the fan wheel 11, and the head end of the second air guide part 13313 is connected to the head end of the first air guide part 13312. Moreover, the air outlet gap 13241 is formed between the first air guide part 13312 of one flow guide member 1331 and the second air guide part 13313 of an adjacent flow guide member 1331.

As shown in FIG. 11, in the reference plane perpendicular to the rotation axis (central axis of the annular opening 1324), the connection line between the head end of the second air guide part 13313 or the head end of the first air guide part 13312 and the rotation axis (central axis of the annular opening 1324) is set as the first reference line a, and the connection line between the tail end of the second air guide part 13313 and the rotation axis (central axis of the annular opening 1324) is set as the ninth reference line b. The second reference line c is located between the first reference line a and the ninth reference line b.

The axis of the annular opening 1324, the axis of the fan wheel 11 (rotation axis), and the axis of the entire ceiling fan are collinear. A length of the second air guide part 13313 is greater than a length of the first air guide part 13312.

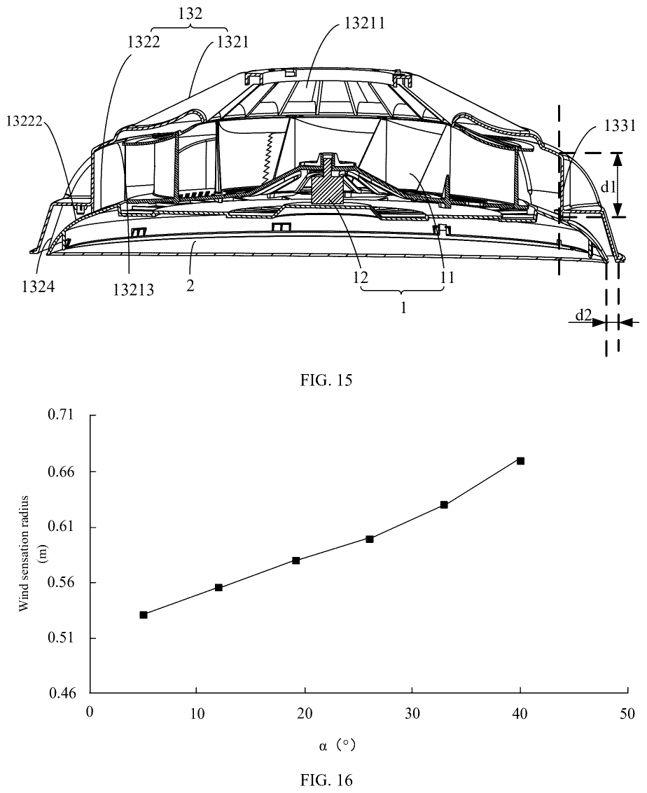

As shown in FIG. 15, the fan mechanism 1 further includes a motor 12 which is fixed below the air duct assembly 132. The fan wheel 11 is in transmissive connection with the motor 12 and the fan wheel 11 is arranged opposite the air inlet gap 13211 of the air duct casing. The fan wheel 11 may be a centrifugal fan or a diagonal fan.

In the case that the flow guide member 1331 includes a first air guide part 13312 and a second air guide part 13313, the first air guide part 13312 may be arc-shaped, straight, or in other shapes.

In the ceiling fan according to the embodiments of the present disclosure, an angle occupied by the second air guide part 13313 of the flow guide member 1331 is an angle between the first reference line a and the ninth reference line b. An angle occupied by the portion shielded by the flow guide member 1331 is an angle between the second reference line c and the ninth reference line b. Since the second reference line c is located between the first reference line a and the ninth reference line b, the angle occupied by the second air guide part 13313 is greater than the angle occupied by the portion shielded by the flow guide member 1331.

In this way, the flow guide member 1331 not only achieves a sufficiently long second air guide part 13313 but also ensures that the length of the shielded portion of the flow guide member 1331 is relatively short such that the ceiling fan delivers air over a long distance and the air blown out from each air outlet 112 can be continuous in the circumferential direction, and the annular airflow from the ceiling fan is more even. Moreover, the above design also allows the first air guide part 13312 to be relatively long, such that the first air guide part 13312 can effectively guide the air.

In some examples, as shown in FIG. 11, the angle between the ninth reference line b and the second reference line c is set as α, where 20°<α<30°.

As shown in FIG. 16, the x-axis represents a, measured in degrees, and the y-axis represents the wind sensation radius, that is, the radius within which a user can feel the airflow from the ceiling fan provided by the embodiments of the present disclosure, measured in meters.

From FIG. 16, it can be observed that as a increases, the wind sensation radius also gradually increases. Since the wind sensation radius is small when 0°<α<20°, it is set that α>20°. In the case that α>30°, although the wind sensation radius continues to increase, it would lead to excessive blockage of the annular opening 12 by the flow guide members 3, such that the air outlet gap 120 is too small and the airflow from the ceiling fan would be uneven. Therefore, in some examples, 20°<α<30°.

In some examples, as shown in FIG. 11, the number of the flow guide member 1331 is set as z, then 130°/α<z<150°/α. That is, the angle occupied by the total portions shielded by the plurality of flow guide members 1331 is a minimum of 130° and a maximum of 150°.

Experiments have shown that in the case that z<130°/α, i.e., zα<130°, the angle occupied by the total portions shielded by the plurality of flow guide members 1331 would be too small, an air outlet area for each air outlet gap 13241 would be caused to be larger, and thus it would be difficult for the air outlet gap 13241 to increase the wind pressure and force effectively. Meanwhile, lengths of the second air guide part 13313 and the first air guide part 13312 would also be caused to be shorter, such that the pressure increase path for the airflow in the second air guide part 13313 and the first air guide part 13312 is shortened, which is not conducive to increasing the air pressure at the air outlet gaps 13241.

However, in the case that z>150°/α, i.e., zα>150°, the angle occupied by the total portions shielded by the plurality of flow guide members 1331 would be too large which would cause the air outlet gaps 13241 to be too small. Although this would increase the air pressure at the air outlet gaps 13241, there is no air blown out from the flow guide members 1331, which would make it difficult for the air blown out from the plurality of air outlet gaps 13241 to be continuous in the circumferential direction, such that the annular air delivery from the ceiling fan is uneven. In addition, if the air outlet gaps 13241 are too small, the wind velocity at the air outlet gaps 13241 would be too high, resulting in increased wind noise. Moreover, in the case that the angle occupied by the total portions shielded by the plurality of flow guide members 1331 is too large, the collision area between the airflow and the flow guide members 1331 would increase, thereby increasing the collision intensity between the airflow and the flow guide members 1331, which would further cause wind noise to be increased.

In some examples, as shown in FIGS. 11, 4≤z≤6. Exemplarily, z=6. If the number z of the flow guide member 1331 is too small, the air outlet gaps 13241 would become too large, such that the wind velocity at the air outlet gaps 13241 is too low, which is not conducive to increasing the air delivery distance from the air outlet gaps 13241. If the number z of flow guide members 1331 is too large, in an aspect, the collision frequency between the airflow and the flow guide members 1331 would be increased, leading to excessive collision intensity between the airflow and the flow guide members 1331 and thus generating greater noise. In another aspect, the air outlet gaps 13241 would become too small, such that the wind velocity at the air outlet gaps 13241 would be too high, resulting in increased wind noise.

In some examples, as shown in FIG. 11, in the reference plane, the angle between the first reference line a and the second reference line c is set as γ, and 0°<γ<15°.

In the case that γ is too large, the angle between the second air guide part 13313 and the first air guide part 13312 would become too small, making it difficult to manufacture the flow guide members 1331. Moreover, the air outlet gaps 13241 would be made to be too large, such that the wind velocity and wind pressure at the air outlet gaps 13241 are too low, which is not conducive to increasing the air delivery distance from the air outlet gaps 13241. In the case that γ is too small, in an aspect, the air outlet gaps 13241 would be made to be too small, causing the wind velocity at the air outlet gaps 13241 to be too high and thus generating greater noise. In another aspect, the spacing between adjacent air outlet gaps 13241 would be made to be too large, preventing the achievement of more even annular airflow.

The above technical solutions allow the air blown out from each air outlet gap 13241 to be continuous in the circumferential direction, achieving a more even annular airflow from the ceiling fan. In addition, the evenness of the air blown out from each air outlet gap 13241 also affects the overall evenness of the annular airflow.

An exemplary explanation of how to improve the evenness of air blown out from each air outlet gap 13241 is provided hereinafter.

In some examples, as shown in FIG. 11, in the reference plane, an angle at the place where the second air guide part 13313 and the first air guide part 13312 are connected is set as δ, and δ is an acute angle.

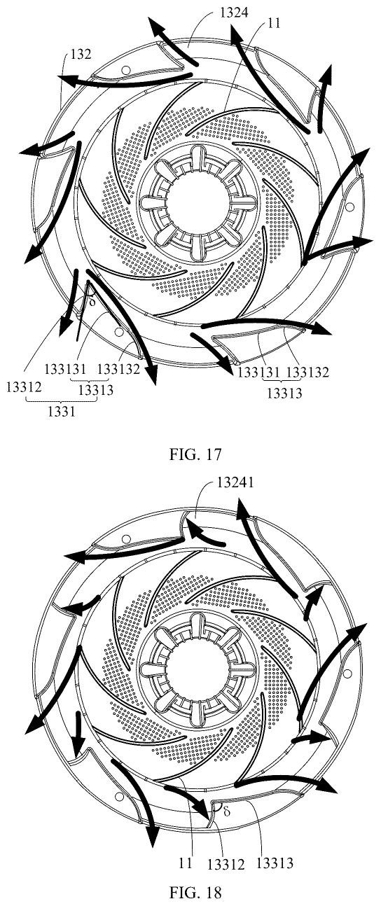

As shown in FIG. 17, setting δ as an acute angle allows a portion of the wind from the fan wheel 11 towards the flow guide member 1331 to flow along the second air guide part 13313 towards the portion, close to the second air guide part 13313, of the air outlet gap 13241, while another portion flows along the first air guide part 13312 towards the portion of, close to the first air guide part 13312, of another air outlet gap 13241. In this way, for an air outlet gap 13241, the portion close to the second air guide part 13313 and the portion close to the first air guide part 13312 both have a large airflow, such that each air outlet gap 13241 achieves more even airflow. Alternatively, it is described as follows: since there is an air outlet gap 13241 provided between the first air guide part 13312 of one flow guide member 1331 and the second air guide part 13313 of an adjacent flow guide member 1331, a portion of the airflow within each air outlet gap 13241 comes from the second air guide part 13313 of one flow guide member 1331, and another portion comes from the first air guide part 13312 of another flow guide member 1331. Therefore, the air blown out from the air outlet gap 13241 is more even.

As shown in FIG. 18, in the case that δ is an obtuse angle, in an aspect, without changing the air guide lengths of the second air guide part 13313 and the first air guide part 13312, an obtuse δ would cause the angle occupied by the portion shielded by the flow guide member 1331 to be greater than the angle occupied by the second air guide part 13313 which results in a longer length of the portion shielded by the flow guide member 1331, and makes annular airflow from the ceiling fan uneven.

In another aspect, it also results in a greater impact between the airflow from the fan wheel 11 and the first air guide part 13312, causing significant airflow impact loss and generating greater wind noise. Since an air outlet gap 13241 is provided between the second air guide part 13313 of a flow guide member 1331 and the first air guide part 13312 of an adjacent flow guide member 1331, in the case that δ is too large, there will be more airflow and stronger wind force at the air outlet gap 13241 close to the second air guide part 13313, while there will be less airflow and weaker wind force at the air outlet gap 13241 close to the first air guide part 13312, leading to uneven airflow at the air outlet gap 13241.

In some examples, as shown in FIGS. 11, 9°<δ<38°. In the case that δ is too small, an effective fillet radius cannot be created at the place where the second air guide part 13313 and the first air guide part 13312 are connected, such that it is difficult to process the flow guide member 1331 and increases the complexity and cost of manufacturing the ceiling fan. Moreover, it would be difficult for the place, where the second air guide part 13313 and the first air guide part 13312 are connected, to guide the airflow, such that the airflow quickly detaches from the place where the second air guide part 13313 and the first air guide part 13312 are connected, thereby causing the airflow to generate greater noise.

In some examples, as shown in FIG. 14, an angle between the tangent at the head end of the second air guide part 13313 and the first reference line a is set as φ, and φ>145°. In this way, the angle between the air blown out from the fan wheel 11 and the second air guide part 13313 can be reduced, such that the impact of the second air guide part 13313 on the airflow is decreased and thus the airflow loss is reduced. As a result, the wind force at the air outlet gap 13241 close to the second air guide part 13313 becomes close to the wind force close to the first air guide part 13312, such that the air outlet gap 13241 achieves more even airflow. In addition, this setup can also reduce the noise generated when the airflow impacts the second air guide part 13313.

In some examples, as shown in FIGS. 14 and 17, the first air guide part 13312 is arc-shaped, and the concave surface of the first air guide part 13312 faces the second air guide part 13313 of the flow guide member 1331 which is closest to the first air guide part 13312. In the reference plane, along the rotational direction of the fan wheel 11, the angle between the tangent of the first air guide part 13312 and the radial direction of the annular opening 1324 (or fan wheel 11) gradually decreases.

In an aspect, compared to a straight-shaped first air guide part 13312, setting the first air guide part 13312 as arc-shaped can increase the length of the first air guide part 13312, and thus the pressurization path of the airflow is increased which is beneficial for increasing wind pressure. Since the second air guide part 13313 is longer, it can reduce the pressure difference between the tail ends of the second air guide part 13313 and the first air guide part 13312 by increasing the length of the first air guide part 13312, thereby resulting in more even airflow from the air outlet gap 13241. Meanwhile, the central angle occupied by the flow guide member 1331 can be reduced without decreasing the air guide length of the second air guide part 13313, i.e., the central angle occupied by the air outlet gap 13241 is larger. In this way, the air blown out from the annular opening 1324 is continuous, that is, the airflow from the annular opening 1324 is even.

In another aspect, the first air guide part 13312 can deflect the airflow radially towards the fan wheel 11, such that the airflow can have a larger radial component after flowing towards the air outlet gap 13241, which is beneficial for the airflow to reach a greater distance.

In some examples, as shown in FIG. 14, a distance from the head end of the first air guide part 13312 to the rotation axis of the fan wheel 11 (or the central axis of the annular opening 1324) is set as r1, and the maximum radius of the fan wheel 11 is set as R, where r1/R≥1.05, such that the head end of the second air guide part 13313 has ample guiding space, which is beneficial for directing the airflow toward the air outlet gap 13241. Moreover, the wind velocity when the airflow reaches the head end of the second air guide part 13313 can be reduced, such that the collision intensity of the airflow with the head end of the second air guide part 13313 is reduced, thereby reducing wind noise.

In the case that r1 is too small, the gap between the head end of the second air guide part 13313 and the edge of the fan wheel 11 would be smaller, such that the guiding space at the head end of the second air guide part 13313 is smaller, such that it is difficult for the air blown out by the fan wheel 11 to be guided by the flow guide member 1331, and thus causes the airflow to easily flow back. Moreover, when the airflow reaches the head end of the second air guide part 13313, the wind velocity would be too high, such that the collision intensity between the airflow and the head end of the second air guide part 13313 is stronger, thereby generating greater wind noise.

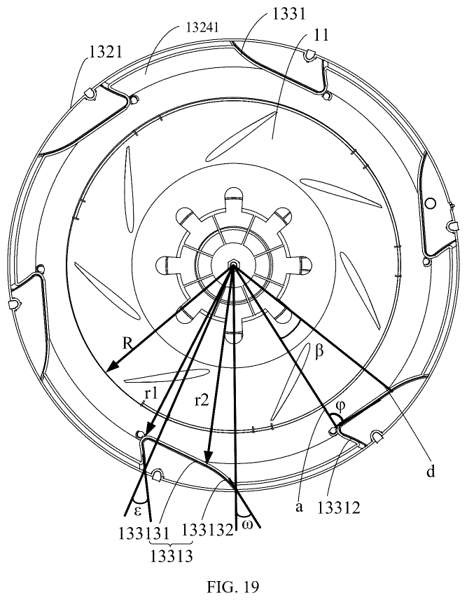

In some examples, as shown in FIG. 19, a distance from the head end of the second air guide part 13313 to the central axis of the annular opening 1324 is set as r1, the maximum radius of the fan wheel 11 is set as the maximum radius R, and the number of the flow guide member 1331 is set as z. According to simulation and test data, it is found that in the case that (0.1+0.01z)R≤r1−R≤0.4R, the noise generated by the ceiling fan is minimized.

In the case that r1−R is too large, the path for the airflow from the fan wheel 11 to the flow guide member 1331 would be too long. The longer the path is, the greater the resistance is encountered by the airflow, and the more energy is lost, thereby causing the airflow to reach the annular opening 1324 at an excessively low speed, and affecting the air delivery distance. In the case that r1−R is too small, the distance between the fan wheel 11 and the flow guide member 1331 would be too short, such that the airflow velocity is higher when the airflow reaches the flow guide member 1331, thereby resulting in a more intense impact on the flow guide member 1331 and causing greater noise.

From the above relationship, it can be observed that r1−R is positively correlated with z, that is, the more flow guide members 1331 there are, the greater the distance between the flow guide members 1331 and the fan wheel 11 is. The airflow would collide with the flow guide members 1331 after flowing out of the fan wheel 11. As the number of the flow guide member 1331 increases, the arrangement of the flow guide members 1331 becomes denser, such that the frequency of collisions between the airflow and the flow guide members 1331 is high, which may result in greater noise generated by the airflow. To reduce the noise of the airflow, as the number z of the flow guide member 1331 increases, r1−R also increases, that is, the distance between the head end of the second air guide part 13313 and the fan wheel 11 becomes larger. In this way, the path from the fan wheel 11 to the head end of the second air guide part 13313 becomes longer, such that the resistance encountered by the airflow is increased, which in turn reduces the airflow velocity when the airflow reaches the head end of the flow guide members 1331. In the case that the airflow velocity is reduced, in an aspect, the lower the airflow velocity, the less wind noise is generated. In another aspect, the lower the airflow velocity, the less intense the collision between the airflow and the flow guide members 1331, thereby reducing the noise generated by the collision between the airflow and the flow guide members 1331. In this way, it can be ensured that even with an increased number of flow guide members 1331, the ceiling fan generates less noise.

From the above relationship, it can also be observed that r1−R is positively correlated with R, that is, the larger the diameter of the fan wheel 11, the greater the distance between the flow guide members 1331 and the fan wheel 11. In the case that the diameter of the fan wheel 11 is increased, the velocity of the airflow flowing out of the fan wheel 11 would be increased. In this case, if the distance between the flow guide members 1331 and the fan wheel 11 is small, the airflow velocity is high when the airflow reaches the flow guide members 1331, such that the collision between the airflow and the flow guide members 1331 is more intense, thereby generating greater noise. Therefore, it is necessary to reduce the airflow velocity when the airflow reaches the flow guide members 1331. According to aerodynamics, it is known that the longer the path the airflow travels, the more resistance the airflow encounters. Thus, it can reduce the airflow velocity when the airflow reaches the flow guide members 1331 by increasing r1−R, such that the intensity of the collision between the airflow and the flow guide members 1331 is decreased, so as to reduce the noise generated by the collision between the airflow and the flow guide members 1331.

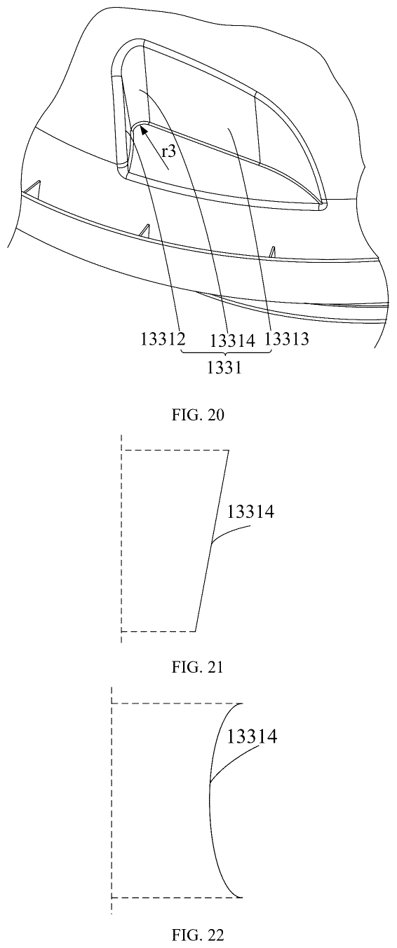

In some examples, as shown in FIGS. 19 and 20, the distance from the head end of the second air guide part 13313 to the rotation axis of the fan wheel 11 (or the central axis of the annular opening 1324) is set as r1, and the radius of the fan wheel 11 is set as R. A transition surface 13314 is provided at the place where the second air guide part 13313 and the first air guide part 13312 are connected, and the radius of the transition surface 13314 is r3. According to simulation and test data, it is found that in the case of 0.5(r1−R)≤r3≤2(r1−R), the noise generated by the ceiling fan is minimized.

In the case that r3 is too small, it would be difficult for the transition surface 13314 to guide the airflow, such that the airflow quickly detaches from the transition surface 13314, and thus causes the airflow to generate greater noise. In the case that r3 is too large, the transition surface 13314 would create more resistance to the airflow, such that greater noise is generated during the collision of the airflow and the flow guide members 1331.

From the above relationship, it can be observed that r3 is positively correlated with r1−R. In the case that r1−R decreases, it indicates that the distance between the flow guide members 1331 and the fan wheel 11 is short, so the velocity of the airflow is high, after flowing out of the fan wheel 11 and reaching the flow guide members 1331, such that the collision between the airflow and the flow guide members 1331 is more intense. In this case, if r3 is increased, the transition surface 13314 would create more resistance to the airflow, thereby further increasing the noise during the collision of the airflow and the flow guide members 1331. Therefore, it should reduce r3 to decrease wind noise.

In some examples, as shown in FIG. 20, a transition surface 13314 is provided at the place where the second air guide part 13313 and the first air guide part 13312 are connected. The transition surface 13314 has at least two positions with different distances to the central axis of the annular opening 1324.

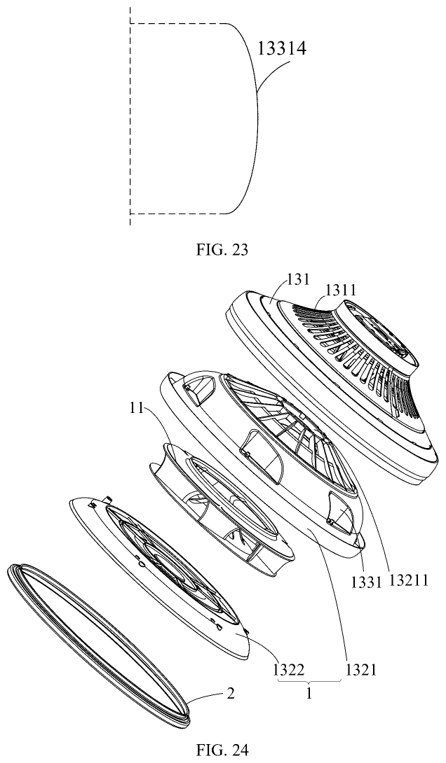

For example, as shown in FIGS. 21 to 23, along the direction from the air inlet 111 towards the annular opening 1324, the distance between the transition surface 13314 and the central axis of the annular opening 1324 gradually increases, or first increases and then decreases, or first decreases and then increases; or at least a portion of the distance gradually increases, or first increases and then decreases, or first decreases and then increases. In this way, it can prevent the airflow from colliding with all positions of the transition surface 13314 simultaneously, and reduce the collision intensity between the airflow and the transition surface 13314, and thus reduces the noise generated by the airflow.

In some examples, as shown in FIGS. 18 and 19, along the rotational direction of the fan wheel 11 (or the circumferential direction of the fan wheel 11), the second air guide part 13313 sequentially includes a first sub-air guide surface 133131 and a second sub-air guide surface 133132. The second sub-air guide surface 133132 is arc-shaped, and a convex surface of the second sub-air guide surface 133132 faces the fan wheel 11.

In an aspect, the second sub-air guide surface 133132 can deflect the airflow direction radially towards the fan wheel 11. Therefore, the airflow can have a larger radial component after flowing towards the air outlet gap 13241, which is beneficial for the airflow to reach a greater distance. Moreover, since the concave surface of the first air guide part 13312 faces the second air guide part 13313 of another flow guide member 1331, an angle between the first air guide part 13312 and the second sub-air guide surface 133132 of the other flow guide member 1331 is small. In this way, the angle between the airflow of the air outlet gap 13241 close to the second sub-air guide surface 133132 and the airflow close to the first air guide part 13312 is small, such that the wind direction across the air outlet gap 13241 is more even, thereby enhancing the evenness of the airflow through the air outlet gap 13241.

In another aspect, the second sub-air guide surface 133132 deflects towards the radial direction of the fan wheel 11, which can reduce the central angle occupied by the flow guide member 1331 without decreasing the air guide length of the second air guide part 13313, so that the central angle occupied by the air outlet gap 13241 is larger. In this way, the air blown out from the annular opening 1324 is continuous, that is, the airflow from the annular opening 1324 is even.

In some examples, as shown in FIG. 14, in the reference plane, the angle between the tangent at the tail end of the second sub-air guide surface 133132 and the connection line between the tail end of the second sub-air guide surface 133132 and the central axis of the annular opening 1324 is set as ω, where 0°<ω<20°. In this way, the angle between the wind direction at the tail end of the second sub-air guide surface 133132 and the radial direction of the annular opening 1324 is small, which is beneficial for increasing the radial air delivery distance of the ceiling fan. Meanwhile, it ensures that the wind direction at the tail end of the second sub-air guide surface 133132 is close to the wind direction at the tail end of the first air guide part 13312, such that the airflow of the air outlet gap 13241 is more even.

In some examples, as shown in FIG. 14, the first sub-air guide surface 133131 is tangential to the second sub-air guide surface 133132 at a place where they are connected, such that the airflow can smoothly flow from a first sub-air guide surface to a second sub-air guide surface 133132, thereby reducing airflow loss. It also prevents the airflow from detaching too quickly from the first sub-air guide surface 133131, thereby reducing the noise generated by the airflow.

In some examples, the concave surface of the first sub-air guide surface 133131 faces the fan wheel 11, which is beneficial for gathering the airflow and guiding the airflow to the second sub-air guide surface 133132.

In some examples, as shown in FIG. 14, the distance from the tail end of the first sub-air guide surface 133131 to the axis of the fan wheel 11 is set as r2, and 1.015<r2/r1<1.2, which is beneficial for the first sub-air guide surface 133131 to gather the airflow and also beneficial for the first sub-air guide surface 133131 to guide the airflow to the second sub-air guide surface 133132. In the case that r2/r1 is too small (e.g., r2/r1<1), it would cause the first sub-air guide surface 133131 to create more resistance to the airflow, thereby leading to airflow loss and generating greater noise when the airflow impacts the first sub-air guide surface 133131. In the case that r2/r1 is too large, the angle change of the first sub-air guide surface 133131 would be too rapid, thereby causing the airflow to easily detach from the first sub-air guide surface 133131 and resulting in greater noise from the airflow.

In some examples, as shown in FIG. 14, in the reference plane, a connection line between the tail end of the first sub-air guide surface 133131 and the central axis of the annular opening 1324 is set as the tenth reference line d, an angle between the ninth reference line b and the tenth reference line d is set as β, and β<α.

In the case that β>α, the length of the second sub-air guide surface 133132 would increase, such that the impact between the airflow and the second sub-air guide surface 133132 is great, such that the airflow from the fan wheel 11 is subjected to greater resistance and thus the load on the fan wheel 11 is increased.

In some examples, as shown in FIGS. 14 and 15, the duct assembly 132 includes a first air duct component 1321 and a second air duct component 1322, and the first air duct component 1321 is sleeved on the second air duct component 1322. An air inlet gap 13211 is formed on the top of the first air duct component 1321, and an annular opening 1324 is formed between the bottom of the first air duct component 1321 and the bottom of the second air duct component 1322. The flow guide member 1331 is connected to the inner wall of the housing.

In some examples, the air inlet gap 13211 may be also located on the side of the first air duct component 1321, or at the bottom of the second air duct component 1322.

In some examples, as shown in FIGS. 11 and 12, the top of the flow guide member 1331 abuts against the first air duct component 1321, and/or the bottom of the flow guide member 1331 abuts against the second air duct component 1322. Moreover, along the airflow direction, as shown in FIGS. 14 and 15, the dimension of the flow guide member 1331 in the vertical direction gradually decreases. Therefore, the space between the portions of the first air duct component 1321, the second air duct component 1322, and the flow guide member 1331 that abut against each other also decreases. Since the total air output of the fan wheel 11 remains constant, and the space between the first air duct component 1321 and the second air duct component 1322 gradually decreases along the airflow direction, the air pressure of the airflow will gradually increase, thereby enhancing the fan's air delivery distance.

In some examples, as shown in FIG. 15, the first air duct component 1321 includes a first arc-shaped part 13213, and the second air duct component 1322 includes a second arc-shaped part 13222. The concave surface of the first arc-shaped part 13213 faces the convex surface of the second arc-shaped part 13222, and a plurality of flow guide members 1331 are located between the first arc-shaped part 13213 and the second arc-shaped part 13222. In this way, the airflow blown out from the fan wheel 11 can flow along the curved path, such that the airflow flows smoothly and the airflow loss caused by the sudden change of the airflow direction is avoided.

In some examples, as shown in FIG. 15, both the top and bottom of the flow guide member 1331 are arc-shaped and fit respectively with the first arc-shaped part 13213 and the second arc-shaped part 13222. An angle between the top of the flow guide member 1331 and the horizontal plane, and/or an angle between the bottom of the flow guide member 1331 and the horizontal plane gradually increases along the airflow direction. Since the airflow blown out from the fan wheel 11 is directed along the horizontal direction and the ceiling fan needs to blow air downward, the angle between the bottom of the flow guide member 1331 and the horizontal plane gradually increases along the airflow direction, such that the airflow can be guided gradually closer to the vertical direction.

In some examples, as shown in FIG. 15, the maximum dimension of the flow guide member 1331 in the vertical direction is d1, and the width of the air outlet gap 13241 is d2, where 2.5<d1/d2<7. Further, 4<d1/d2<6.

Since the diameter of the first air duct component 1321 and the diameter of the second air duct component 1322 are larger than the diameter of the fan wheel 11, in the case that d1/d2 is too small, it may result in that a ventilation area of the annular opening 1324 (a ventilation area between the tail ends of the first arc-shaped part 13213 and the second arc-shaped part 13222) is greater than the ventilation area of the edge of the fan wheel 11, such that the velocity of the airflow within the air duct gradually decreases and the airflow is likely to form vortices within the air duct, thereby shortening the air delivery distance of the annular opening 1324.

In the case that d1/d2 is too large, although it would result in that the ventilation area of the annular opening 1324 is smaller than the ventilation area of the edge of the fan wheel 11, it would result in that the ventilation area of the annular opening 1324 obstructs the airflow, such that the amount of air output at the annular opening 1324 is too small, which is not conducive to increasing the air delivery distance and may also generate greater noise.

In some examples, the transition surface 13314 is provided at the place where the second air guide part 13313 and the first air guide part 13312 are connected. The transition surface 13314 has at least two positions with different radii. Therefore, the airflow does not collide with the entire second air guide part 13313 simultaneously, thereby reducing the collision intensity between the airflow and the second air guide part 13313 and thus reducing the noise generated by the airflow.

Exemplarily, along the direction from the air inlet 111 towards the annular opening 1324, the radius of the transition surface 13314 gradually decreases.

In some examples, the transition surface 13314 is a chamfer between the second air guide part 13313 and the first air guide part 13312, and the radius of the transition surface 13314 refers to the chamfer radius. Along the direction from the air inlet 111 towards the annular opening 1324, the radius of the transition surface 13314 gradually increases or decreases, or at least partially increases or decreases gradually.

In this way, in an aspect, along the direction towards the air inlet 111, the distance r1 from the head end of the second air guide part 13313 to the central axis of the annular opening 1324 gradually increases, such that the airflow does not collide with the entire second air guide part 13313 simultaneously, but first collides with one end, away from the annular opening 1324, of the second air guide part 13313, and then with one end, close to the annular opening 1324, of the first air guide surface. This reduces the collision intensity between the airflow and the second air guide part 13313, thereby reducing the noise generated by the airflow. Correspondingly, along the direction away from the bottom of the flow guide member 1331, the distance from the head end of the first air guide part 13312 to the central axis of the annular opening 1324 gradually decreases, such that the airflow does not collide with the entire first air guide part 13312 simultaneously, but first collides with one end, close to the annular opening 1324, of the first air guide part 13312, and then with one end, away from the annular opening 1324, of the first air guide part 13312. This reduces the collision intensity between the airflow and the first air guide part 13312, thereby reducing the noise generated by the airflow.

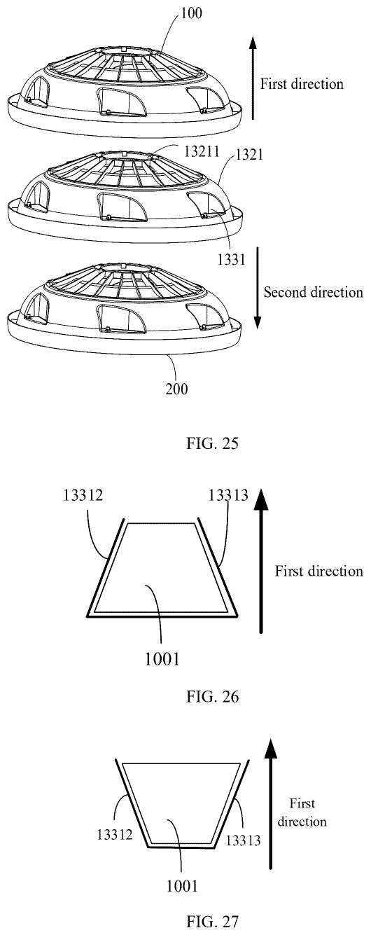

In another aspect, in the case that the flow guide member 1331 and the first air duct component 1321 are integrally molded by injection molding, as shown in FIG. 25, the flow guide member 1331 and the first air duct component 1321 are formed between an upper mold 100 and a lower mold 200. The upper mold 100 is located on the outer side of the first air duct component 1321, and the lower mold 200 is located on the inner side of the first air duct component 1321. After the flow guide member 1331 and the first air duct component 1321 are molded, the upper mold 100 and the lower mold 200 need to be pulled out.

As shown in FIG. 25, when pulling the mold, the upper mold 100 needs to be pulled out along the first direction, where the first direction is the direction in which the first air duct component 1321 gradually approaches the air inlet gap 13211 along the axial direction. A position, opposite the flow guide member 1331, on an inner side of the upper mold 100 forms a protrusion 1001, and the protrusion 1001 is located on an inner side of an outer surface of the flow guide member 1331.

As shown in FIG. 26, in the case that the radius r3 of the transition surface 13314 gradually decreases along the direction towards the air inlet gap 13211 (towards the rotation axis), the distance between the second air guide part 13313 and the first air guide part 13312 of the flow guide member 1331 will gradually decrease along the first direction. In this way, when pulling out the upper mold 100, the protrusion will be obstructed by the second air guide part 13313 and the first air guide part 13312, and thus it cannot release the mold. As shown in FIG. 27, in the case that the radius r3 of the transition surface 13314 gradually increases along the direction towards the air inlet gap 13211, the distance between the second air guide part 13313 and the first air guide part 13312 of the flow guide member 1331 will gradually increase along the first direction. In this way, during the demolding process, the protrusion can be smoothly pulled out from the second air guide part 13313 and the first air guide part 13312.

As shown in FIG. 25, when pulling the mold, the lower mold 200 needs to be pulled out along the second direction, where the second direction is the direction in which the first air duct component 1321 gradually moves away from the air inlet gap 13211 along the axial direction. The position, opposite the flow guide member 1331, of the lower mold 200 forms a groove, and the groove is located on the outer side of the inner surface of the flow guide member 1331.

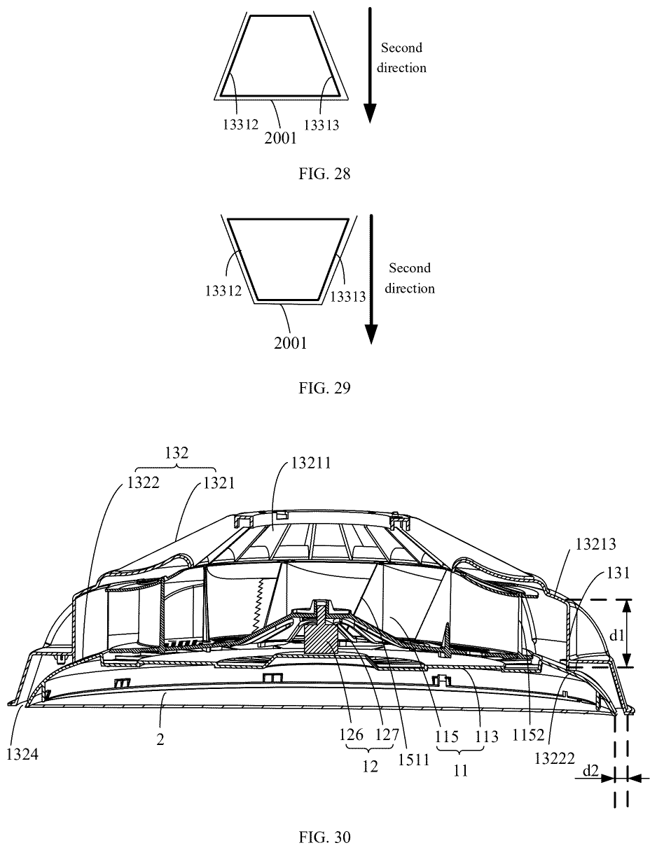

As shown in FIG. 28, in the case that the radius r3 of the transition surface 13314 gradually decreases along the direction towards the air inlet 111, the distance between the second air guide part 13313 and the first air guide part 13312 of the flow guide member 1331 will gradually increase along the second direction. In this way, when pulling out the lower mold 200, the groove will be obstructed by the second air guide part 13313 and the first air guide part 13312, and thus it cannot release the mold. As shown in FIG. 29, in the case that the radius r3 of the transition surface 13314 gradually increases along the direction towards the air inlet 111, the distance between the second air guide part 13313 and the first air guide part 13312 of the flow guide member 1331 will gradually decrease along the second direction. In this way, during the demolding process, the groove 2001 can be smoothly pulled out from between the second air guide part 13313 and the first air guide part 13312.

In other examples, the flow guide member 1331 is integrated with the second air duct component 1322. Alternatively, the flow guide member 1331 is a separate part connected to the first air duct component 1321 and the second air duct component 1322 via connecting parts 1132.

In some examples, as shown in FIG. 15, the second air duct component 1322 is connected to the bottom of the flow guide member 1331, thereby achieving the connection between the second air duct component 1322 and the first air duct component 1321. Since the airflow generated by the fan wheel 11 does not flow out from a position of the flow guide member 1331opposite the annular opening 1324, the connecting parts 1132 (such as a bolt and a screw) are arranged at the bottom of the flow guide member 1331, so as to not obstruct the airflow.

In some examples, sound-absorbing cotton is attached to the outer wall surface of the first air duct component 1321 to reduce noise generated during airflow.

It should be noted that in some embodiments, terms such as “concave surface” and “convex surface” herein refer to the general direction of the surfaces. In other embodiments, a local convex surface may be arranged within a concave surface for other effects.

The embodiments of the present disclosure further provide a fan lamp, which includes the ceiling fan and the lighting mechanism 2 mentioned above. The lighting mechanism 2 is also referred to as a lamp module, which is arranged at the bottom of the air duct assembly 132 of the ceiling fan.

In some examples, as shown in FIG. 24, the fan lamp further includes an outer housing 131, and the outer housing 131 is sleeved on the first air duct component 1321. The outer housing 131 is provided with an air intake 1311, and the air intake 1311 is aligned with the air inlet 111 on the fan wheel 11 and the air inlet gap 13211 on the air duct assembly 132.

In some examples, as shown in FIGS. 8 and 15, the second air duct component 1322 is provided with a receiving slot. The lighting mechanism 2 can directly arrange the light source in the receiving slot, and in this case the second air duct component 1322 may be considered as installation base for the light source. Alternatively, the lamp module is an integrated piece that is detachably connected to the bottom of the second air duct component 1322.

An exemplary description of the implementation of the fan wheel is provided hereinafter.

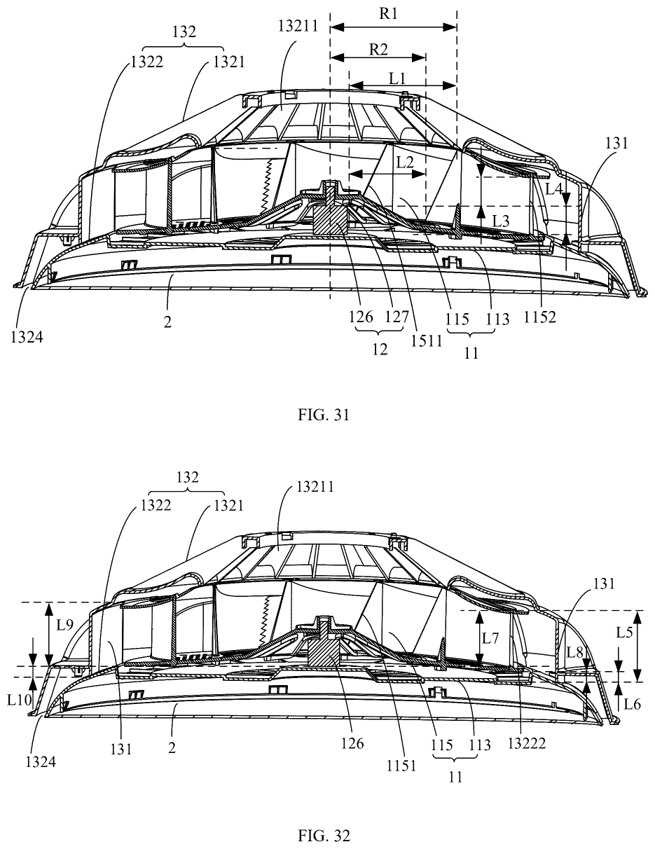

In some examples, as shown in FIGS. 30 and 31, the fan mechanism 1 includes a fan wheel 11 and a motor 12. The fan wheel 11 includes a bottom plate 113 and a plurality of blades 115, the plurality of blades 115 are fixed to the bottom plate 113, and the plurality of blades 115 surround the air inlet gap 13211. The motor 12 includes a main body part 126 and an output shaft 127, and the output shaft 127 is rotatably connected to the main body part 126. The main body part 126 is located below the bottom plate 113, and the output shaft 127 passes through the bottom plate 113.

A radial distance between the top of the leading edge 1151 of the blade 115 and the top of the main body part 126 is set as L1, and a radial distance between the bottom of the leading edge 1151 and the top of the main body part 126 is set as L2, where L1>L2. The leading edge 1151 is the edge, close to the air inlet gap 13211, of the blade 115.

According to the technical solutions provided by the embodiments of the present disclosure, the greater the radial distance between the leading edge 1151 and the top of the main body part 126, the farther the leading edge 1151 is from the air inlet gap 13211, and the less air intake at the leading edge 1151. By setting L1>L2, the top of the leading edge 1151 can be made farther from the air inlet gap 13211, thereby reducing the amount of air intake at the top of the leading edge 1151. Since the closer to the top of the leading edge 1151, the higher the wind velocity, and the more noise is generated, it can reduce the noise of the fan lamp by reducing the amount of air intake at the top of the leading edge 1151.

In some examples, as shown in FIGS. 33 to 35, the leading edge 1151 of the blade 115 is provided with a forward protrusion structure 11511 which is located between the top and bottom of the leading edge 1151.

In some examples, as shown in FIG. 36, a distance between the top of the leading edge 1151 and the central axis of the annular opening 1324 is set as R1, a distance between the bottom of the leading edge 1151 and the central axis of the annular opening 1324 is set as R2, and a distance between the forward protrusion structure 11511 and the central axis of the annular opening 1324 is set as R3, where R1>R2>R3. Since the forward protrusion structure 11511 is located at the foremost side of the leading edge 1151, the distance R3 between the forward protrusion structure 11511 and the central axis of the annular opening 1324 is the smallest, thus R1 and R2 are both greater than R3. In this way, the forward protrusion structure 11511 can change the airflow direction earlier, thereby reducing vortices and thus lowering wind noise.

The greater the distance between the leading edge 1151 and the central axis of the annular opening 1324, the farther the leading edge 1151 is from the air inlet gap 13211, and the less air intake at the leading edge 1151. By setting R1>R2, the amount of air intake at the top of the leading edge 1151 is reduced. Since the higher the wind velocity, the closer to the top of the leading edge 1151, and the more noise is generated, and thus it can lower the noise of the fan lamp by reducing the amount of air intake at the top of the leading edge 1151.

In some examples, as shown in FIG. 36, the height of the leading edge 1151 is set as H1, and the height of the forward protrusion structure 11511 from the bottom plate 113 is set as H2, where 0.5H1<H2≤0.8H1. According to simulation and test data, it is found that in the case of 0.5H1<H2≤0.8H1, the noise reduction effect of the leading edge 1151 is optimal. In the case that the height H2 of the forward protrusion structure 11511 from the bottom plate 113 is too high, the distance between the forward protrusion structure 11511 and the top of the leading edge 1151 will be too small. According to aerodynamics, it is known that the smaller the cross-sectional area of the space through which the airflow passes, the faster the airflow velocity. Therefore, in the case that the distance between the forward protrusion structure 11511 and the top of the leading edge 1151 is too small, the airflow velocity between the forward protrusion structure 11511 and the top of the leading edge 1151 would be faster, such that the wind noise there is greater, which is not conducive to reducing the wind noise of the fan wheel 11.

In some examples, as shown in FIGS. 30 and 31, the top of the main body part 126 is higher than the bottom of the trailing edge 1152 of the blade 115, where the trailing edge 1152 is opposite the leading edge 1151. In this way, the main body part 126 can fully utilize the internal space of the fan wheel 11, such that the height of the fan wheel 11 is small and thus the volume of the fan lamp is small.

In some examples, as shown in FIG. 31, an axial distance between the top of the trailing edge 1152 of the blade 115 and the top of the main body part 126 is set as L3, and an axial distance between the bottom of the trailing edge 1152 and the top of the main body part 126 is set as L4, where L3>L4, such that the trailing edge 1152 of the blade 115 can guide the airflow as much as possible. In the case that L4>L3, it would cause a large portion of the trailing edge 1152 to be lower than the top of the main body part 126, which may cause the air flowing from the leading edge 1151 of the blade 115 to concentrate in the top area of the trailing edge 1152. In an aspect, it would lead to uneven airflow at the trailing edge 1152. In another aspect, it would result in a stronger impact of the airflow on the top area of the trailing edge 1152, and thus generate greater noise.

Alternatively, as shown in FIGS. 31 and 32, the fan lamp further includes a plurality of flow guide members 1331, and the plurality of flow guide members 1331 surround the fan wheel 11. An axial distance between the top of the trailing edge 1152 of the blade 115 and the bottom of the head end of the flow guide member 1331 is set as L5, and an axial distance between the bottom of the trailing edge 1152 and the bottom of the head end of the flow guide member 1331 is set as L6, where L5>L6.

The shape of the flow guide member 1331 is not specifically limited in the embodiments of the present disclosure. As shown in FIG. 9, the flow guide member 1331 is in the shape of a shielding tongue. Alternatively, as shown in FIG. 33, the flow guide member 1331 is sheet-shaped.

In some examples, as shown in FIG. 32, an axial distance between the top of the trailing edge 1152 of the blade 115 and a first side of the main body part 126 is set as L7, and a distance between the bottom of the trailing edge 1152 and the bottom of the first side of the main body part 126 is set as L8, where L7>L8. The first side of the main body part 126 refers to one side, away from the bottom plate 113, of the main body part 126. Alternatively, the fan lamp further includes a plurality of flow guide members 1331, and the plurality of flow guide members 1331 surround the fan wheel 11. An axial distance between the top of the head end of the flow guide member 1331 and the bottom of the main body part 126 is set as L9, and an axial distance between the bottom of the head end of the flow guide member 1331 and the bottom of the main body part 126 is set as L10, where L9>L10. In the case that the main body part 126 extends into the interior of the fan wheel 11, the first side of the main body part 126 is the top of the main body part 126. In the case that the main body part 126 is located below the fan wheel 11, the first side of the main body part 126 is the bottom of the main body part 126.

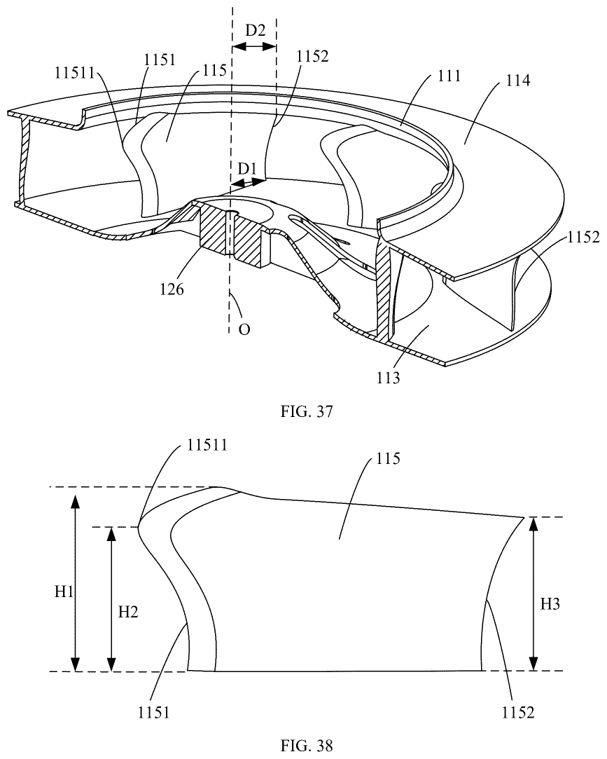

In some examples, as shown in FIGS. 36 and 38, along the direction towards the bottom plate 113, the distance between the trailing edge 1152 of the blade 115 and the central axis of the annular opening 1324 gradually decreases, where the trailing edge 1152 is opposite the leading edge 1151. In this way, it is possible to prevent the airflow distributed along the axial direction of the trailing edge 1152 from detaching simultaneously from the trailing edge 1152. Airflow detachment from the trailing edge 1152 is one of the main causes of wind noise generated by the blade 115. Therefore, it can reduce the wind noise at the trailing edge 1152 by preventing simultaneous detachment of airflow from the trailing edge 1152.

In some examples, as shown in FIG. 38, along the direction towards the bottom plate 113, the rate at which the distance between the trailing edge 1152 of the blade 115 and the central axis of the annular opening 1324 decreases gradually slows down. In the case that the rate of decrease in distance between the position of the trailing edge 1152 close to the bottom and the central axis of the annular opening 1324 remains high, it would result in the bottom of the blade 115 being too short, such that the airflow acceleration path is too short, leading to an excessively low wind velocity at the bottom of the trailing edge 1152, which is not conducive to increasing the air delivery distance of the fan lamp.

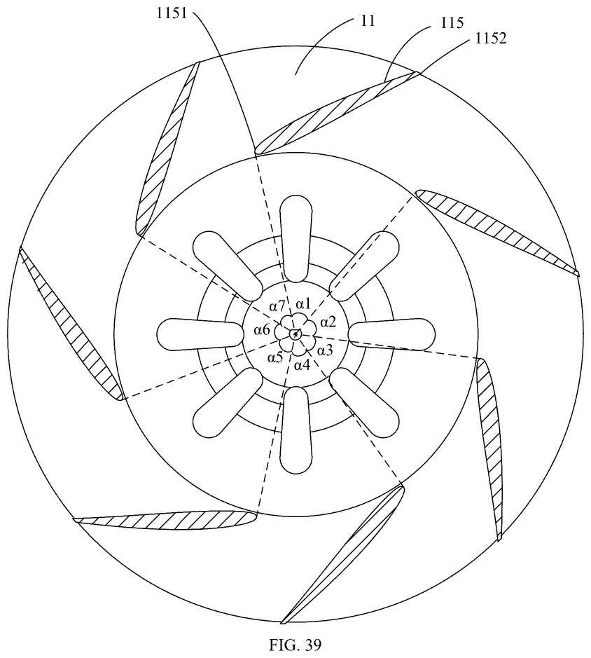

In some examples, as shown in FIG. 39, on the same reference cross-section, angles between the leading edges 1151 of every two adjacent blades 115 and the central axis of the annular opening 1324 are not entirely the same, where the reference cross-section is perpendicular to the central axis of the annular opening 1324.

In the related art, the reason why the fan wheel 11 generates strong discrete noise is that a plurality of blades 115 are evenly distributed in the circumferential direction, such that pulsation frequencies generated when the airflow impacts any blade 115 are identical, thereby enhancing the pulsation frequency of the fan wheel 11 and thus resulting in greater noise of the fan wheel 11. Therefore, in the embodiments of the present disclosure, the angles between lines connecting the leading edges 1151 of every two adjacent blades 115 to the central axis are configured to be not entirely the same, which can prevent the airflow from colliding with the leading edges 1151 of a plurality of blades 115 simultaneously, thus reducing the wind noise of the fan wheel 11.

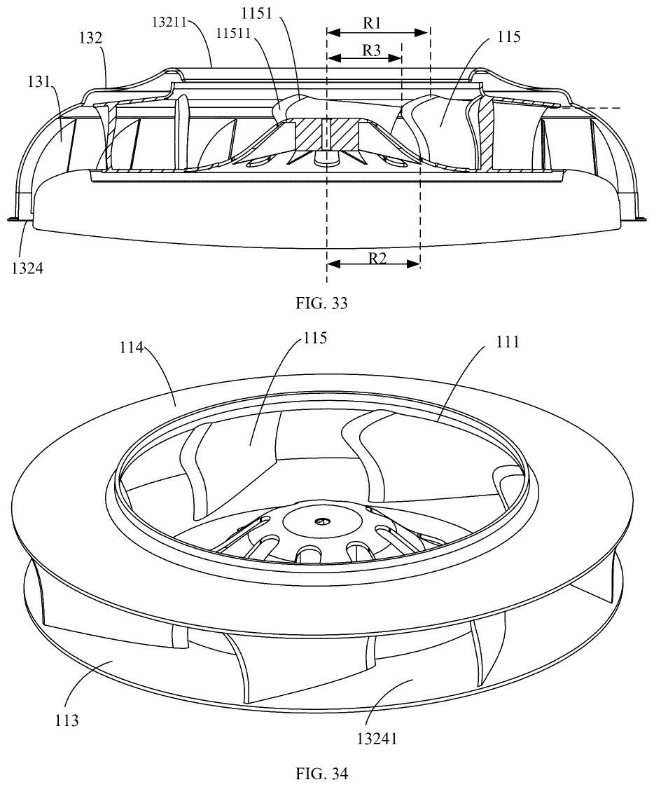

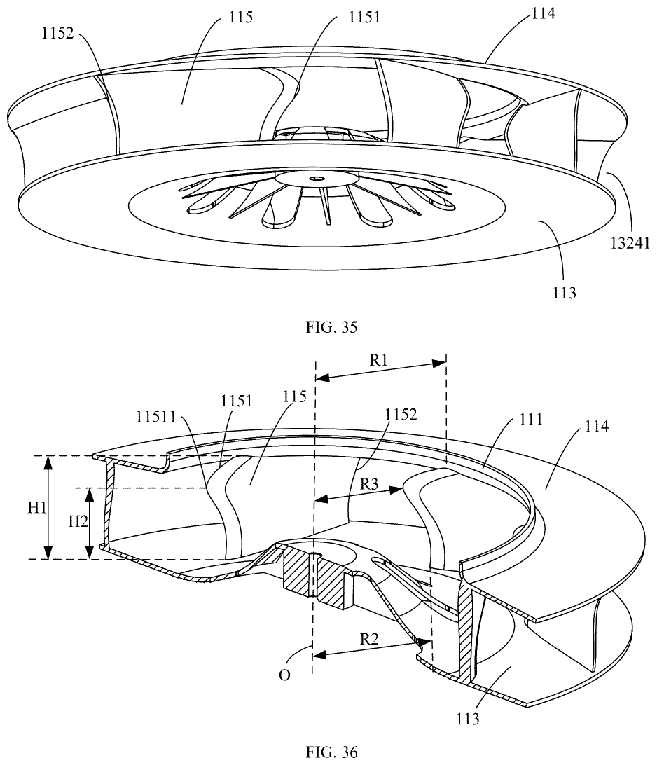

The embodiments of the present disclosure further provide a fan wheel 11. As shown in FIGS. 34 and 35, the fan wheel 11 includes a bottom plate 113 and a plurality of blades 115, and the plurality of blades 115 are fixed to the bottom plate 113. As shown in FIGS. 33 and 34, the leading edge 1151 of the blade 115 is provided with a forward protrusion structure 11511, where the leading edge 1151 is the edge, close to the central axis O of the fan wheel 11, of the blade 115. As shown in FIG. 36, the height of the leading edge 1151 is set as H1, and the height of the forward protrusion structure 11511 from the bottom plate 113 is set as H2, where 0.5H1<H2≤0.8H1.

In some examples, as shown in FIGS. 34 and 35, the fan wheel 11 further includes a top plate 114, and the plurality of blades 115 are fixed between the top plate 114 and the bottom plate 113. The top plate 114 is provided with an air inlet 111, and the plurality of blades 115 surround the air inlet 111. An air outlet 112 is formed between the edges of the top plate 114 and the bottom plate 113, and the trailing edges 1152 of the blades 115 divide the air outlet 112 into a plurality of air outlet gaps 13241. In the case that the fan wheel 11 rotates, airflow enters the interior of the fan wheel 11 through the air inlet 111, accelerates within the blades 115, and then flows out through the air outlet 112.

According to the technical solutions provided by the embodiments of the present disclosure, in the case that the fan wheel 11 is in operation, airflow enters the interior of the fan wheel 11 and flows towards the leading edge 1151 of the blade 115. The leading edge 1151 is provided with a forward protrusion structure 11511, and the forward protrusion structure 11511 is a biomimetic design of a protrusion structure at the leading edge of a bird wing. The protrusion structure at the leading edge of a bird wing can alter the direction of airflow, thereby reducing vortices in the airflow and thus decreasing air resistance during flight. According to biomimetic principles, it is known that the forward protrusion structure 11511 can mimic the protrusion structure at the leading edge of a bird's wing to reduce vortices at the leading edge 1151 of the blade 115, which allows for smoother airflow and thus reduces the air resistance encountered by the leading edge 1151 of the blade 115, thereby decreasing wind noise at the leading edge 1151. Moreover, it can increase the local mass of the leading edge 1151 by arranging the forward protrusion structure 11511 at the leading edge 1151, thereby reducing the flutter of the blade 115 caused by aerodynamic forces and thus lowering noise.

In addition, since the upper half region of the leading edge 1151 of the blade 115 is closer to the air inlet gap 13211, the wind velocity in the upper half region of the leading edge 1151 is greater. According to aerodynamics, it is known that higher wind velocities are more likely to generate vortices, thereby leading to greater wind noise. Therefore, reducing the vortex in the upper half region of the leading edge 1151 can effectively reduce noise for the fan wheel 11. Therefore, it can allow the forward protrusion structure 11511 to be closer to the upper half region of the leading edge 1151 by setting H2>0.5H1, and thus reduce the air resistance in the upper half region of the leading edge 1151 and decrease the wind noise at the upper half region of the leading edge 1151.

According to simulation and test data, it is found that in the case of 0.5H1<H2≤0.8H1, the noise reduction effect of the leading edge 1151 is optimal. In the case that the height H2 of the forward protrusion structure 11511 from the bottom plate 113 is too high, the distance between the forward protrusion structure 11511 and the top of the leading edge 1151 will be too small. According to aerodynamics, it is known that the smaller the cross-sectional area of the space through which the airflow passes, the faster the airflow velocity. Therefore, in the case that the distance between the forward protrusion structure 11511 and the top of the leading edge 1151 is too small, the airflow velocity between the forward protrusion structure 11511 and the top of the leading edge 1151 would be faster, such that the wind noise there is greater, which is not conducive to reducing the wind noise of the fan wheel 11.

In some examples, as shown in FIG. 36, the distance between the forward protrusion structure 11511 and the central axis O of the fan wheel 11 is set as R3, the distance between the bottom of the leading edge 1151 and the central axis O is set as R2, and the distance between the top of the leading edge 1151 and the central axis O is set as R1, where R1>R2>R3.

Since the forward protrusion structure 11511 is located at the foremost side of the leading edge 1151, the distance R3 between the forward protrusion structure 11511 and the central axis O is the smallest, thus R1 and R2 are both greater than R3. In this way, the forward protrusion structure 11511 can change the airflow direction earlier, thereby reducing vortices and thus lowering wind noise.

The closer the leading edge 1151 is to the central axis O, the closer the leading edge 11511 is to the air inlet gap 13211, the sooner the leading edge guides the airflow, and the more air intake at the leading edge 11511. Therefore, setting R1>R2 allows for a greater amount of air intake at the bottom of the leading edge 11511 and a smaller amount of air intake at the top. In the case that the amount of air intake at the air inlet gap 13211 is the same, the greater the amount of air intake at the bottom of the leading edge 11511, the smaller the amount of air intake at the top of the leading edge 11511. Since the wind velocity at the bottom of the leading edge 1151 is lower, the noise generated is also lower, thus the more amount of air intake at the bottom of the leading edge 1151, the less noise is generated by the blade 115.

In some examples, as shown in FIGS. 37 and 38, along the direction towards the bottom plate 113, the distance between the trailing edge 1152 of the blade 115 and the central axis O of the fan wheel 11 gradually decreases, where the trailing edge 1152 is opposite the leading edge 1151. In this way, it is possible to prevent the airflow distributed along the axial direction of the trailing edge 1152 from detaching simultaneously from the trailing edge 1152. Airflow detachment from the trailing edge 1152 is one of the main causes of wind noise generated by the blade 115. Therefore, it can reduce the wind noise at the trailing edge 1152 by preventing simultaneous detachment of airflow from the trailing edge 1152.

In some examples, as shown in FIGS. 37 and 38, the distance between the bottom of the trailing edge 1152 and the central axis O is set as D1, the distance between the top of the trailing edge 1152 and the central axis O is set as D2, and the height of the trailing edge 1152 is set as H3, where 0.05H3≤D2−D1≤0.1H3.

Given ΔD=D2−D1, in the case that ΔD is too small, the airflow easily detaches simultaneously from both the top and bottom of the trailing edge 1152, which is not conducive to reducing wind noise at the trailing edge 1152. Since the blade 115 cannot extend beyond the outer edge of the bottom plate 113, in the case that ΔD is too large, the bottom of the trailing edge 1152 would be too short. This would cause the airflow path at the bottom of the trailing edge 1152 to be too small, making the airflow velocity and pressure at the bottom of the trailing edge 1152 significantly lower than those at the top of the trailing edge 1152. This leads to an uneven pressure distribution at the trailing edge 1152, which can affect the stable operation of the fan wheel 11 and may lead to increased noise of the fan wheel 11. According to simulation and test data, it is found that in the case that 0.05H3≤ΔD≤0.1H3, the noise generated by the fan wheel 11 is minimized.

In some examples, as shown in FIG. 38, the trailing edge 1152 is concave on the longitudinal section of the blade 115. Since the wind velocity of the airflow is higher in the middle portion and lower half of the trailing edge 1152, setting the trailing edge 1152 as a concave surface allows the airflow in the middle portion and the lower half to detach from the trailing edge 1152 sooner which reduces the acceleration path of the airflow in the middle portion and lower half of the trailing edge 1152, and thus decreases the airflow velocity in the regions and is beneficial for reducing wind noise at the trailing edge 1152.

In some examples, as shown in FIG. 39, on the same reference cross-section, the angles between lines connecting the leading edges 1151 of every two adjacent blades 115 to the central axis O of the fan wheel 11 are not entirely the same. The reference cross-section is perpendicular to the central axis O.

In the related art, the reason why the fan wheel 11 generates strong discrete noise is that a plurality of blades 115 are evenly distributed in the circumferential direction, such that pulsation frequencies generated when the airflow impacts any blade 115 are identical, thereby enhancing the pulsation frequency of the fan wheel 11 and thus resulting in greater noise of the fan wheel 11. Therefore, in the embodiments of the present disclosure, the angles between lines connecting the leading edges 1151 of every two adjacent blades 115 to the central axis O of the fan wheel 11 are configured to be not entirely the same, which can prevent the airflow from colliding with the leading edges 1151 of a plurality of blades 115 simultaneously, thus reducing the wind noise of the fan wheel 11.

Through the above design, the plurality of blades 115 are distributed unevenly and thus it may cause the center of mass of the fan wheel 11 to deviate from the geometric center of the fan wheel 11, such that it is difficult for the fan wheel 11 to achieve dynamic balance during rotation, thereby leading to vibration when the fan wheel 11 rotates. Therefore, to ensure that the blades 115 can reduce noise and can also align the center of mass with the geometric center of the fan wheel 11, the embodiments of the present disclosure use a sinusoidal frequency-modulated non-equidistant angular distribution formula for calculation to determine the angles between lines connecting the leading edges 1151 of every two adjacent blades 115 to the central axis O of the fan wheel 11.

In some examples, as shown in FIG. 39, the fan wheel 11 includes seven blades 115.

The angles between lines connecting the leading edges 1151 of every two adjacent blades 115 to the central axis O of the fan wheel are determined based on the formula αi=αi′+Δα sin (Kαi′). K represents the number of groups, and K is set as 1 in the present disclosure; αi′ represents the circumferential arrangement angle of the i-th blade 115 when the blades 115 are evenly arranged (the angle between a connecting line of the i-th blade 115 and the central axis O of the fan wheel and another connecting line of the (i+1)-th blade 115 and the central axis O of the fan wheel); αi represents the circumferential arrangement angle of the i-th blade 115 when the blades 115 are unevenly arranged; and Δα represents the phase modulation amount. Here, Δα=360°×nonuniform coefficient/number of blades, where the nonuniform coefficient is defined as desired (e.g., 0.44).

On the same reference cross-section, the angles formed by the leading edges 1151 of every two adjacent blades 115 and the central axis O of the fan wheel are respectively α1, α2, α3, α4, α5, α6, and α7. After calculation, α1, . . . and α7 are 57.22°, 47.42°, 47.42°, 57.22°, 52.86°, 45° and 52.86°, respectively.

Taking into account the precision and tolerances during the injection molding of the fan wheel, the angles formed by the leading edges 1151 of every two adjacent blades 115 and the central axis O of the fan wheel are 56.5°-57.5°, 47.0°-48.0°, 47.0°-48.0°, 56.5°-57.5°, 52.5°-53.5°, 44.5°-45.5° and 52.5°-53.5°, respectively. In this way, the wind noise of the fan wheel can be reduced, and the alignment of the center of mass with the geometric center of the fan wheel can be maximized.

In some examples, as shown in FIG. 37, on the longitudinal section of the blade 115, the area between the forward protrusion structure 11511 and the top of the leading edge 1151 is convex, and the area between the forward protrusion structure 11511 and the bottom of the leading edge 1151 is concave. According to simulation and test data, it is known that setting the leading edge 1151 into the above shape is beneficial for reducing wind noise at the leading edge 1151.

In some examples, as shown in FIG. 39, on the cross-section of the blade 115, the end surface of the leading edge 1151 is arc-shaped. Compared to the leading edge 1151 with a plane-shaped end surface, the arc shape produces less resistance to airflow and improves the cutting and guiding effects on the airflow, which is beneficial for reducing the wind noise of the fan wheel.

In some examples, as shown in FIG. 39, the thickness of the blade 115 first increases and then decreases along the direction towards the trailing edge 1152. The cross-section of the blade 115 can adopt a NACA6508 airfoil, such that the surface of the blade 115 is less prone to boundary layer separation. According to aerodynamics, it is known that boundary layer separation is one of the main causes of wind noise generated by blades. Therefore, reducing boundary layer separation on the surface of the blade 115 can lower the aerodynamic noise of the fan wheel.

According to the technical solutions provided by the embodiments of the present disclosure, since the noise generated during the rotation of the fan wheel in the fan lamp is small, the fan lamp can produce less noise during operation, thereby providing a better user experience.

It should be noted that in some embodiments, terms such as “concave surface” and “convex surface” herein refer to the general direction of the surfaces. In other embodiments, a local convex surface may be arranged within a concave surface for other effects.

The present disclosure further provides a fan lamp, which includes an air duct assembly 132 and a fan wheel 11, with the fan wheel 11 located inside the air duct assembly 132.

In some examples, as shown in FIG. 32, the fan wheel 2 includes a bottom plate 22 and a plurality of blades 23, and the plurality of blades 23 are fixed to the bottom plate 22. As shown in FIGS. 33 and 34, the leading edge 1151 of the blade 115 is provided with a forward protrusion structure 11511, where the leading edge 1151 is the edge, close to the central axis O of the fan wheel 11, of the blade 115. As shown in FIG. 36, the height of the leading edge 1151 is set as H1, and the height of the forward protrusion structure 11511 from the bottom plate 113 is set as H2, where 0.5H1<H2≤0.8H1.

The forward protrusion structure 11511 is a biomimetic design of the protrusion structure at the head edge of a bird wing. The protrusion structure at the head edge of a bird wing can alter the direction of airflow, thereby reducing vortices in the airflow and thus decreasing air resistance during flight. According to biomimetic principles, it is known that the forward protrusion structure 11511 can mimic the protrusion structure at the leading edge of a bird's wing to reduce vortices at the leading edge 1151 of the blade 115, which allows for smoother airflow and thus reduces the air resistance encountered by the leading edge 1151 of the blade 115, thereby decreasing wind noise at the leading edge 1151. Moreover, arranging the forward protrusion structure 11511 at the leading edge 1151 can increase the local mass of the leading edge 1151, thereby reducing the flutter of the blade 115 caused by aerodynamic forces and thus lowering noise.

In addition, since the upper half region of the leading edge 1151 of the blade 115 is closer to the air inlet gap 13211, the wind velocity in the upper half region of the leading edge 1151 is greater. According to aerodynamics, it is known that higher wind velocities are more likely to generate vortices, thereby leading to greater wind noise. Therefore, reducing the vortex in the upper half region of the leading edge 1151 can effectively reduce noise for the fan wheel 11. Setting H2>0.5H1 can allow the forward protrusion structure 11511 to be closer to the upper half region of the leading edge 1151, thereby reducing air resistance in the upper half region of the leading edge 1151 and thus decreasing the wind noise at the upper half region of the leading edge 1151.

According to simulation and test data, it is found that in the case of 0.5H1<H2≤0.8H1, the noise reduction effect of the leading edge 1151 is optimal. In the case that the height H2 of the forward protrusion structure 11511 from the bottom plate 113 is too high, the distance between the forward protrusion structure 11511 and the top of the leading edge 1151 will be too small. According to aerodynamics, it is known that the smaller the cross-sectional area of the space through which the airflow passes, the faster the airflow velocity. Therefore, in the case that the distance between the forward protrusion structure 11511 and the top of the leading edge 1151 is too small, the airflow velocity between the forward protrusion structure 11511 and the top of the leading edge 1151 would be faster, such that the wind noise there is greater, which is not conducive to reducing the wind noise of the fan wheel 11.

In some examples, as shown in FIG. 36, the distance between the forward protrusion structure 11511 and the central axis O of the fan wheel 11 is set as R3, the distance between the bottom of the leading edge 1151 and the central axis O is set as R2, and the distance between the top of the leading edge 1151 and the central axis O is set as R1, with R1>R2>R3.

Since the forward protrusion structure 11511 is located at the foremost side of the leading edge 1151, the distance R3 between the forward protrusion structure 11511 and the central axis O is the smallest and thus R1 and R2 are both greater than R3. In this way, the forward protrusion structure 11511 can change the airflow direction earlier, thereby reducing vortices and thus lowering wind noise.

The closer the leading edge 1151 is to the central axis O, the closer the leading edge 11511 is to the air inlet gap 13211, the sooner the leading edge guides the airflow, and the more air intake at the leading edge 11511. Therefore, setting R1>R2 allows for a greater amount of air intake at the bottom of the leading edge 11511 and a smaller amount of air intake at the top. In the case that the amount of air intake at the air inlet gap 13211 is the same, the greater the amount of air intake at the bottom of the leading edge 11511, the smaller the amount of air intake at the top of the leading edge 11511. Since the wind velocity at the bottom of the leading edge 1151 is lower, the noise generated is also lower, thus the more amount of air intake at the bottom of the leading edge 1151, the less noise is generated by the blade 115.

In some examples, as shown in FIGS. 37 and 38, along the direction towards the bottom plate 113, the distance between the trailing edge 1152 of the blade 115 and the central axis O of the fan wheel 11 gradually decreases, where the trailing edge 1152 is opposite the leading edge 1151. In this way, it is possible to prevent the airflow distributed along the axial direction of the trailing edge 1152 from detaching simultaneously from the trailing edge 1152. Airflow detachment from the trailing edge 1152 is one of the main causes of wind noise generated by the blade 115. Therefore, it can reduce the wind noise at the trailing edge 1152 by preventing simultaneous detachment of airflow from the trailing edge 1152.

In some examples, as shown in FIGS. 37 and 38, the distance between the bottom of the trailing edge 1152 and the central axis O is set as D1, the distance between the top of the trailing edge 1152 and the central axis O is set as D2, and the height of the trailing edge 1152 is set as H3, where 0.05H3≤D2−D1≤0.1H3.

Given ΔD=D2−D1, in the case that ΔD is too small, the airflow easily detaches simultaneously from both the top and bottom of the trailing edge 1152, which is not conducive to reducing wind noise at the trailing edge 1152. Since the blade 115 cannot extend beyond the outer edge of the bottom plate 113, in the case that ΔD is too large, the bottom of the trailing edge 1152 would be too short. This would cause the airflow path at the bottom of the trailing edge 1152 to be too small, making the airflow velocity and pressure at the bottom of the trailing edge 1152 significantly lower than those at the top of the trailing edge 1152. This leads to an uneven pressure distribution at the trailing edge 1152, which can affect the stable operation of the fan wheel 11 and may lead to increased noise of the fan wheel 11. According to simulation and test data, it is found that in the case that 0.05H3≤ΔD≤0.1H3, the noise generated by the fan wheel 11 is minimized.

In some examples, as shown in FIG. 39, on the same reference cross-section, the angles between lines which respectively connect the leading edges 1151 of every two adjacent blades 115 to the central axis O of the fan wheel 11 are not entirely the same. The reference cross-section is perpendicular to the central axis O.

In the related art, the reason why the fan wheel 11 generates strong discrete noise is that a plurality of blades 115 are evenly distributed in the circumferential direction, such that pulsation frequencies generated when the airflow impacts any blade 115 are identical, thereby enhancing the pulsation frequency of the fan wheel 11 and thus resulting in greater noise of the fan wheel 11. Therefore, in the embodiments of the present disclosure, the angles between lines connecting the leading edges 1151 of every two adjacent blades 115 to the central axis O of the fan wheel 11 are configured to be not entirely the same, which can prevent the airflow from colliding with the leading edges 1151 of a plurality of blades 115 simultaneously, thus reducing the wind noise of the fan wheel 11.

Through the above design, the plurality of blades 115 are distributed unevenly and thus it may cause the center of mass of the fan wheel 11 to deviate from the geometric center of the fan wheel 2, such that it is difficult for the fan wheel 11 to achieve dynamic balance during rotation, thereby leading to vibration when the fan wheel 2 rotates. Therefore, to ensure that the blades 115 can reduce noise and can also align the center of mass with the geometric center of the fan wheel, the embodiments of the present disclosure use a sinusoidal frequency-modulated non-equidistant angular distribution formula for calculation, to determine the angles between lines connecting the leading edges 11511 of every two adjacent blades 115 to the central axis O of the fan wheel.

In some examples, as shown in FIG. 39, the fan wheel includes seven blades 115.

The angles between lines connecting the leading edges 1151 of every two adjacent blades 115 to the central axis O of the fan wheel are determined based on the formula αi=αi′+Δα sin (Kαi′). K represents the number of groups, and K is set as 1 in the present disclosure; αi′ represents the circumferential arrangement angle of the i-th blade 115 when the blades 115 are evenly arranged (the angle between a connecting line of the i-th blade 115 and the central axis O of the fan wheel and another connecting line of the (i+1)-th blade 115 and the central axis O of the fan wheel); αi represents the circumferential arrangement angle of the i-th blade 115 when the blades 115 are unevenly arranged; and Δα represents the phase modulation amount. Here, Δα=360°×nonuniform coefficient/number of blades, where the nonuniform coefficient being defined as desired (e.g., 0.44).

On the same reference cross-section, the angles formed by the leading edges 1151 of every two adjacent blades 115 and the central axis O of the fan wheel are respectively α1, α2, α3, α4, α5, α6, and α7. After calculation, α1, . . . and α7 are 57.22°, 47.42°, 47.42°, 57.22°, 52.86°, 45°, and 52.86°, respectively.

Taking into account the precision and tolerances during the injection molding of the fan wheel, the angles formed by the leading edges 1151 of every two adjacent blades 115 and the central axis O of the fan wheel are 56.5°-57.5°, 47.0°-48.0°, 47.0°-48.0°, 56.5°-57.5°, 52.5°-53.5°, 44.5°-45.5° and 52.5°-53.5°, respectively. In this way, the wind noise of the fan wheel can be reduced, and the alignment of the center of mass with the geometric center of the fan wheel can be maximized.

In the present disclosure, it should be understood that the terms “first”, “second”, “third”, etc., are only used for descriptive purposes and should not be interpreted as indicating or implying relative importance or implicitly specifying the quantity of the indicated technical features.

Other embodiments of the present disclosure are apparent to those skilled in the art from consideration of the specification and practice of the present disclosure disclosed herein. The present disclosure is intended to cover any variations, uses, or adaptations of the present disclosure following the general principles of the present disclosure and including known common knowledge or customary technical means undisclosed in the art of the present disclosure. The specification and embodiments are only considered exemplary.

It should be understood that the present disclosure is not limited to the precise arrangements that have been described above and shown in the accompanying drawings, and that various modifications and changes may be made without departing from the scope thereof. The scope of the present disclosure is limited only by the appended claims.

1-93. (canceled)

94. A bladeless fan lamp, comprising a fan mechanism, wherein the fan mechanism comprises a fan wheel, an air duct assembly and a flow guide assembly, and wherein,
an air inlet is formed on a top of the fan wheel, an air outlet is formed on a side surface of the fan wheel, the air outlet is arranged along a circumferential direction of the fan wheel, and the fan wheel comprises a bottom plate and a plurality of blades;
the air duct assembly surrounds the fan wheel and forms an air duct space along the circumferential direction of the fan wheel, an entrance of the air duct space faces and communicates with the air outlet of the fan wheel, and a bottom of the air duct assembly forms an annular opening;
the flow guide assembly is located inside the air duct space and is connected to the air duct assembly; and
the flow guide assembly comprises a plurality of flow guide members, and the flow guide member is provided with a first air guide part and a second air guide part, wherein a tail end of the first air guide part is connected to the air duct assembly, a head end of the second air guide part is connected to a head end of the first air guide part, and the second air guide part faces the fan wheel.

95. The bladeless fan lamp according to claim 94,
wherein in a reference plane perpendicular to a central axis of the annular opening, a connection line between the head end of the first air guide part and the central axis of the annular opening is set as a first reference line, and a connection line between the tail end of the first air guide part and the central axis of the annular opening is set as a second reference line, the second reference line and the first reference line are arranged sequentially along the circumferential direction of the fan wheel; and
wherein in the reference plane perpendicular to the central axis of the annular opening, a connection line between a tail end of the second air guide part and the central axis of the annular opening is set as a ninth reference line, and the second reference line is located between the first reference line and the ninth reference line.

96. The bladeless fan lamp according to claim 95, wherein the plurality of blades are arranged in an annular configuration and surround the air inlet; and
wherein in the reference plane perpendicular to the central axis of the annular opening, a connection line between a tail end of the blade and the rotation axis of the fan wheel is set as a third reference line, a straight line perpendicular to the third reference line at the tail end of the blade is set as a fourth reference line, an obtuse angle formed between the fourth reference line and a connection line between the head end and the tail end of the blade is set as λ1, a connection line between the head end of the first air guide part and the rotation axis of the fan wheel is set as a fifth reference line, a straight line perpendicular to the fifth reference line at the head end of the first air guide part is set as a sixth reference line, and an acute angle formed between the sixth reference line and a tangent at the head end of the first air guide part is set as λ2, and λ1-90°≤λ2≤λ1-80°.

97. The bladeless fan lamp according to claim 96, wherein a connection line between the tail end of the first air guide part and the rotation axis of the fan wheel is set as a seventh reference line, a straight line perpendicular to the seventh reference line at the tail end of the first air guide part is set as an eighth reference line, and an acute angle formed between the eighth reference line and a tangent at the tail end of the first air guide part is set as λ3, and λ2+20°≤λ3≤λ2+40°.

98. The bladeless fan lamp according to claim 95, wherein an angle between the ninth reference line and the second reference line is set as α, and 20°<α<30°.

99. The bladeless fan lamp according to claim 94, wherein the plurality of blades are arranged in an annular configuration and surround the air inlet, and
wherein a leading edge of the blade is provided with a forward protrusion structure which is located between a top and a bottom of the leading edge, and protrudes in a direction towards the air inlet, wherein the leading edge is an edge, close to the air inlet, of the blade.

100. The bladeless fan lamp according to claim 99, wherein a height of the leading edge is set as H1, and a height of the forward protrusion structure from the bottom plate is set as H2, and 0.5H1<H2≤0.8H1.

101. The bladeless fan lamp according to claim 99, wherein a height of a trailing edge of the blade is set as H1, and a height difference between the top of the head end of the first air guide part and the forward protrusion structure is set as H2, and 0<H2≤0.2H1, wherein the trailing edge is opposite the leading edge.

102. The bladeless fan lamp according to claim 94, wherein along a direction towards the bottom plate, a distance between the trailing edge of the blade and the central axis of the annular opening gradually decreases, and the trailing edge is opposite the leading edge; and
wherein along the direction towards the bottom plate, a rate at which the distance between the trailing edge of the blade and the central axis of the annular opening decreases gradually slows down.

103. The bladeless fan lamp according to claim 94, wherein on a same reference cross-section, angles between leading edges of every two adjacent blades and the central axis of the annular opening are not entirely the same, and the reference cross-section is perpendicular to the central axis of the annular opening; and
wherein along the direction towards the bottom plate, a distance between the trailing edge of the blade and the rotation axis of the fan wheel gradually decreases, and the trailing edge is opposite the leading edge.

104. The bladeless fan lamp according to claim 99, wherein the trailing edge of the blade is concave on a longitudinal section of the blade;
wherein on the longitudinal section of the blade, an area between the forward protrusion structure and the top of the leading edge is convex, and an area between the forward protrusion structure and the bottom of the leading edge is concave; and
wherein a thickness of the blade first increases and then decreases along a direction away from the leading edge.

105. The bladeless fan lamp according to claim 94, wherein along a direction from the air inlet towards the annular opening of the air duct assembly, a distance between the head end of the first air guide part and the central axis of the annular opening gradually increases or gradually decreases.

106. The bladeless fan lamp according to claim 94, wherein a distance between a top of the head end of the first air guide part and the central axis of the annular opening is set as L1, a distance between a bottom of the head end of the first air guide part and the central axis of the annular opening is set as L2, and a maximum radius of the fan wheel is set as R, and L2>L1, and 0.05L2−R≤L2−L1≤0.2L2−R.

107. The bladeless fan lamp according to claim 94, wherein a transition surface is provided at a place where the second air guide part and the first air guide part are connected, and
the transition surface has at least two positions with different distances to the central axis of the annular opening.

108. The bladeless fan lamp according to claim 94, wherein along the direction from the air inlet towards the annular opening of the air duct assembly, a distance between the transition surface and the central axis of the annular opening gradually increases, or gradually decreases, or first increases and then decreases, or first decreases and then increases.

109. The bladeless fan lamp according to claim 95, wherein in the reference plane, an angle between the first reference line and the second reference line is set as γ, and 0°<γ<15°.

110. The bladeless fan lamp according to claim 95, wherein in the reference plane, an angle at a place, where the first air guide part and the second air guide part are connected, is set as δ, and δ is an acute angle.

111. The bladeless fan lamp according to claim 94, along the circumferential direction of the fan wheel, the second air guide part sequentially comprises a first sub-air guide surface and a second sub-air guide surface, and the second sub-air guide surface is arc-shaped, and a convex surface of the second sub-air guide surface faces the fan wheel.

112. The bladeless fan lamp according to claim 94, wherein in the reference plane, an angle between a tangent at a tail end of the second sub-air guide surface and a connection line between the tail end of the second sub-air guide surface and the central axis of the annular opening is set as ω, and 0°<ω<20°.
